(19) United States
(12) Patent Application Publication
(10) Pub. No.: US 2014/0057239 A1
(43) Pub. Date: Feb. 27, 2014

(54) METHODS AND APPARATUSES FOR FACILITATING ONLINE KNOWLEDGE TRANSFERS

(71) Applicant: DISCOVERY COMMUNICATIONS, LLC., Silver Spring, MD (US)

(72) Inventors: Gabriel G. VEHOVSKY, Evanston, IL (US); Andrew O'Dower, Chicago, IL (US); Christopher S. Cote, Chicago, IL (US); Won J. You, Chicago, IL (US)

(21) Appl. No.: 14/010,338

(22) Filed: Aug. 26, 2013

Related U.S. Application Data
(60) Provisional application No. 61/693,037, filed on Aug. 24, 2012.
(60) Provisional application No. 61/869,425, filed on Aug. 23, 2013.

(51) Int. Cl. G09B 5/06

(52) U.S. Cl. CPC G09B 5/06
USPC 434/322

(57) ABSTRACT

Methods and systems for facilitating online knowledge transfers. The methods and systems may include receiving content, including learning opportunities and learning information from a plurality of sources and transforming the source format of the received content into a common system format when the source format of the content does not match the system format. In addition, the methods and systems include filtering and indexing the content and populating a data repository with the indexed content in the system format. The methods and systems include transmitting a content feed with the content in the system format for generation on an output mechanism.

### RELATED APPLICATIONS

This application claims the benefit of priority to U.S. Provisional Application No. 61/693,037 entitled “Methods and Apparatuses for Facilitating Online Knowledge Transfers,” filed Aug. 24, 2012 and U.S. Provisional Application No. 61/869,425 entitled “Methods and Apparatuses for Facilitating Online Knowledge Transfers,” filed August 23, 2013. The preceding applications are incorporated by reference in their entirety herein.

### BACKGROUND OF THE INVENTION

When users are looking to take a class and/or learn a new hobby or skill, users typically use a search engine on the Internet to try to find an appropriate learning opportunity. However, because leading search engines typically index billions of pages of content, the user may receive a large number of search results in response to a search query, which may or may not be relevant to the learning opportunity the user is looking for. Moreover, the user may have to filter the search results and determine whether the instructors of the learning opportunities are legitimate instructors capable to teaching the subject matter. In addition, if the user is required to pay for the course online, the user may be uneasy providing credit card information to a stranger; and furthermore, if the user ends up engaging with more than the provider of the knowledge the user is interested in, the user may need to transact with multiple entities.

Thus, there is a need in the art to provide, among other things, methods and systems for consolidating online learning opportunities into a single area and facilitating the transfer and sale of learning opportunities among knowledge seekers and knowledge owners.

### SUMMARY

Aspects of the present invention relate to methods and apparatuses that, among other things, provide an interface and platform that facilitates online knowledge transfers among knowledge owners and knowledge seekers. The methods and apparatuses may also provide centralized electronic commerce and customer service for facilitating online knowledge transfers. With various aspects of the invention taken into consideration, their cumulative impact will create a consolidated and centralized platform specifically designed to enable an effective, safe and efficient way for knowledge owners to transact with knowledge seekers.

Additional advantages and novel features relating to aspects of the present invention will be set forth in part in the description that follows, and in part will become more apparent to those skilled in the art upon examination of the following or upon learning by practice thereof.

### BRIEF DESCRIPTION OF THE FIGURES

In the drawings:

FIG. 1 illustrates an example connectivity system in accordance with aspects of the present invention;

FIG. 2 illustrates an example content manager component in accordance with an aspect the present invention;

FIG. 3 illustrates an example system in accordance with an aspect of the present invention;

FIG. 4 illustrates an example display component in accordance with an aspect of the present invention;

FIG. 5 illustrates an example content delivery component in accordance with an aspect of the present invention;

FIG. 6 illustrates an example learning queue manager component in accordance with an aspect of the present invention;

FIG. 7 illustrates an example user account manager component in accordance with an aspect of the present invention;

FIG. 8 illustrates an example access manager component in accordance with an aspect of the present invention;

FIG. 9 illustrates an example content feed in accordance with an aspect of the present invention;

FIG. 10 illustrates an example system in accordance with an aspect of the present invention;

FIG. 11 illustrates an example method flow for normalizing content in accordance with aspects of the present invention;

FIG. 12 illustrates an example method flow for searching for a learning opportunity in accordance with an aspect of the present invention;

FIG. 13 illustrates an example method flow for searching for learning opportunities in accordance with aspects of the present invention;

FIG. 14 illustrates an example method flow for searching for opportunities in accordance with aspects of the present invention;

FIG. 15 illustrates an example method flow for managing a learning queue in accordance with aspects of the present invention;

FIG. 16 illustrates an example method flow for creating a profile page in accordance with an aspect of the present invention;

FIG. 17 illustrates an example method flow for facilitating a payment in accordance with aspects of the present invention;

FIGS. 18A-18X illustrate example screen shots in accordance with aspects of the present invention.

FIG. 19 illustrates various features of an example computer system for use in conjunction with aspects of the present invention; and

FIG. 20 illustrates an exemplary system diagram of various hardware components and other features for use in accordance with aspects of the present invention.

### DETAILED DESCRIPTION

Aspects of the present invention relate to methods and apparatuses that provide a platform for facilitating and enhancing online knowledge transfers among knowledge owners and knowledge seekers. The methods and apparatuses may consolidate online learning opportunities in a single place and allow consumers (e.g., knowledge seekers) to search for learning opportunities provided by various knowledge owners.

The methods and apparatuses may also provide a centralized electronic commerce and customer service for facilitating online knowledge transfers. The methods and apparatuses may allow consumers to search for learning opportunities, learn more about a variety of the learning opportunities, and pay for the selected learning opportunities all via a single platform.

In addition, the methods and apparatuses may track the number of classes that users of the system have taken and/or have taught. The methods and apparatuses may generate a virtual transcript illustrating the achievements of users of the system. The virtual transcript may be shared with other users via, for example, social media networks, blogs and/or profile pages created using the platform. By offering this feature, consumers will be able to keep track of online learning opportunities they have engaged with online and easily share those accomplishments to help demonstrate capabilities and knowledge they've established.

The methods and apparatuses may also be used to rate and vet knowledge owners to provide consumers with additional information to help a consumer decide which knowledge owner the consumer would like to learn from. For example, the methods and apparatuses may allow users to create profile pages to promote the knowledge owner's ability to teach a particular skill. The methods and apparatuses may also allow for social validation of the knowledge owners. For example, the methods and apparatuses may pull information from various social media networks, such as Facebook™, Twitter™, Linkedin™, blogs, etc. relating to the knowledge owners experience and/or knowledge. In addition, the methods and apparatuses may allow users to rank and/or post comments relating to knowledge owners' experience and/or knowledge. The social validation information may be used in the rating and vetting of knowledge owners to help consumers decide which knowledge owners to learn from.

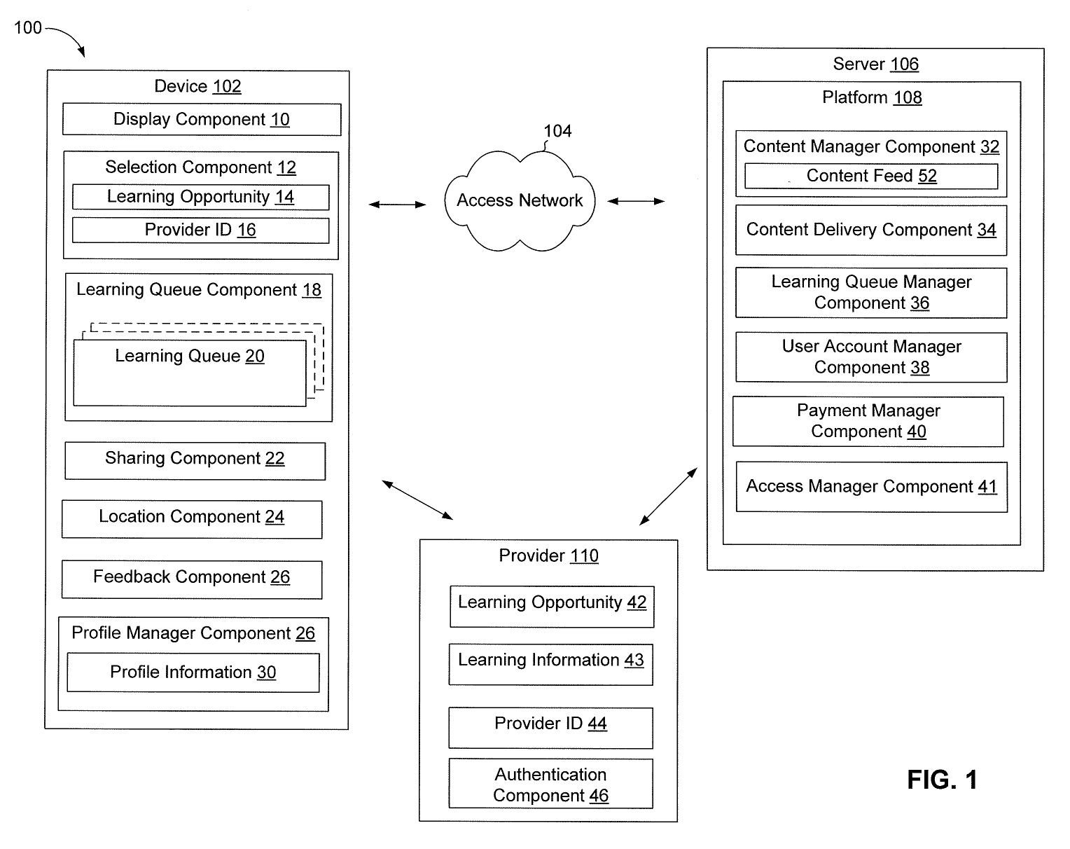

Referring now to FIG. 1, illustrated is a system 100 that may be used to facilitate online knowledge transfers in accordance with aspects of the present invention. System 100 may include a server/computer 106 in communication with one or more devices 102 via an access network 104. In addition, system 100 may include one or more providers 110 in communication with devices 102 and server 106 via access network 104.

Devices 102 may include any suitable mobile or portable computing or communications device, such as a cellular device, that may connect to an access network. Devices 102 may be, for example, a tablet, a laptop, a personal computer, a cellular telephone, a navigation system, a computing device, a camera, a personal digital assistant (PDA), a music device, a gaming device or a handheld device having wireless connection capability, among other devices.

Server 106 may include platform 108, which may be configured to facilitate online knowledge transfers among knowledge seekers and knowledge providers 110. In an aspect, one or more users may access platform 108 using, for example, devices 102. For example, a user (e.g., a knowledge seeker) may enter a request to search for a learning opportunity using device 102. Learning opportunities may include, for example, classes for professional development and/or learning a new skill, hobby, sport, etc. Device 102 may transmit the search request to platform 108 via, for example, access network 104. In addition, platform 108 may receive the search request from device 102 and perform the requested search. Platform 108 may generate search results for learning opportunities corresponding to the search request to present to the user of device 102, and device 102 may receive the search results from platform 108 and present the search results on a display of device 102. The user may select one or more of the learning opportunities associated with provider 110 presented on device 102. Device 102 may transmit the selected learning opportunity to platform 108. Upon receiving the selected learning opportunity, platform 108 may facilitate the purchase and sale of the selected learning opportunity from provider 110.

In addition, a user (e.g., a knowledge owner) may use device 102 to share knowledge with other individuals. For example, the user may be able to teach other individuals a particular skill through a class. Thus, the user may use device 102 to notify platform 108 that the user has various skills, and may offer to teach these skills in various classes. Platform 108 may receive the class information from device 102 and may store the class information, for example, in a data repository that may be accessed when performing requested searches for learning opportunities.

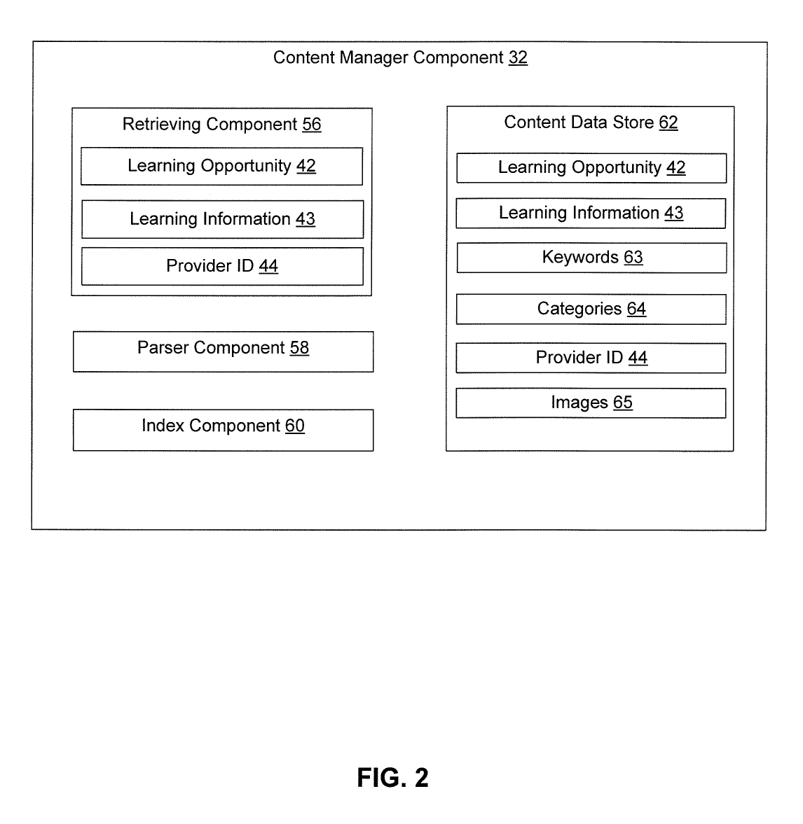

Server 106 may include a content manager component 32 operable to retrieve learning opportunities 42 (FIG. 2) from one or more providers 110 and store the retrieved learning opportunities 42 in a content data store 62 (FIG. 2). Referring now to FIG. 2, illustrated therein is an example content manager component 32 in accordance with an aspect of the present invention.

Content manager component may include a retrieving component 56 for retrieving learning opportunities 42 and learning information 43 from providers 110. For example, retrieving component 56 may identify each provider 110 through a provider ID 44 and may access the learning opportunities 42 and learning information 43 from provider 110. Learning opportunities may include, for example, classes for professional development and/or learning a new skill, hobby, sport, etc. In addition, learning information may include, but is not limited to, provider information (e.g., name of the provider, overview of the provider, ratings of the provider, experience of the provider), class name, class overview information, a preview of the class, class times, class ratings, level of difficulty for the class, class language information, instructor information, instructor rating, price, class location, modality for the class, accreditation information (e.g., college credit, certifications, and transcripts), keywords associated with the class, prerequisites for the class, etc. Retrieving component 56 may associate the provider ID 44 with the learning opportunities 42 and learning information 43 retrieved from provider 110. Retrieving component 56 may retrieve the information from provider 110, for example, through an application programming interface (API) feed from provider 110, hypertext markup language (HTML) content of provider 110, extensible markup language (XML) content of provider 110, or using Java script object notation (JSON), rich site summary (RSS) feeds, or Atom language programming. In an aspect, retrieving component 56 may be or include a crawler that accesses each provider 110 and retrieves the learning opportunities 42 and learning information 43 from provider 110.

Content manager component 32 may also include a parser component 58 for parsing the received learning opportunities 42 and learning information 43 into a common system format for platform 108. Each provider 110 may provide the learning opportunities 42 and learning information 43 in a different source format, for example. In an aspect, parser component 58 may manipulate the received content from the original source format into a common system format. By manipulating the received content into a common system format, the content may be more easily be further manipulated, organized, and indexed. In addition, by manipulating the received content into a common system format, the system may add metadata to the content to include additional attributes and data points. Parser component 58 may also add metadata to the manipulated content. Metadata may include, but is not limited to, keywords, categories, images, source IDs, descriptions, topics, social media information, and individuals associated with the content.

Content manager component 32 may also include an index component 60 for indexing the received learning opportunities 42 and learning information 43. Index component 60 may aggregate and organize the received content, for example, based on provider IDs and metadata associated with the content. In an aspect, index component 60 may map the received content into index fields for efficient searches.

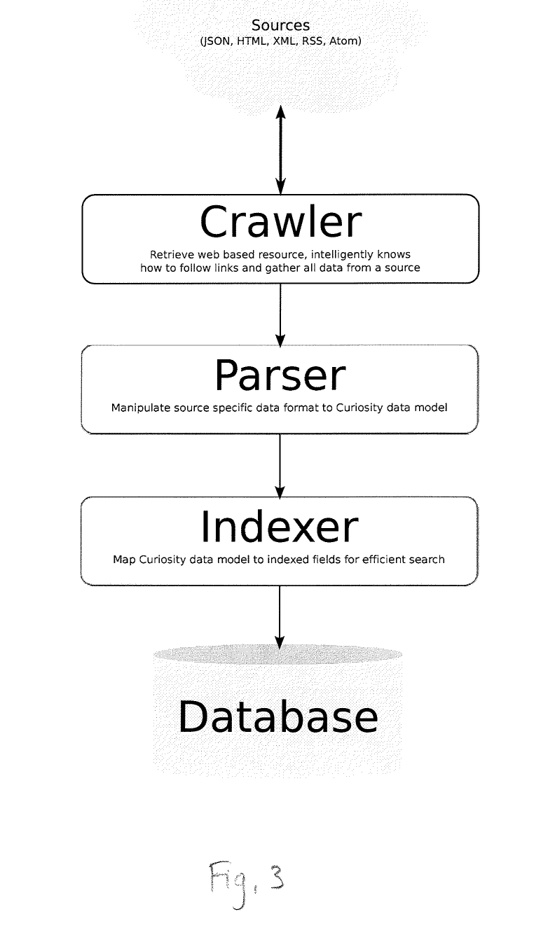

Index component 60 may interface with a content data store 62 to store the indexed content. In an aspect, content data store 62 may store, for each learning opportunity 42, data retrieved for the learning information 43 associated with the learning opportunity, keywords 63, categories 64, provider ID 44, images 65, and/or any other metadata and/or indexing that may have been applied to the learning opportunity 42. As data is received from providers 110, content data store 62 may maintain an updated indexed data repository of various learning opportunities 42 received from providers 110. As such, content data store 62 may be dynamically updated as new content is retrieved from providers 110 and/or content is updated by providers 110. FIG. 3 illustrates an example system diagram using content manager component 32 in accordance with an aspect of the present invention.

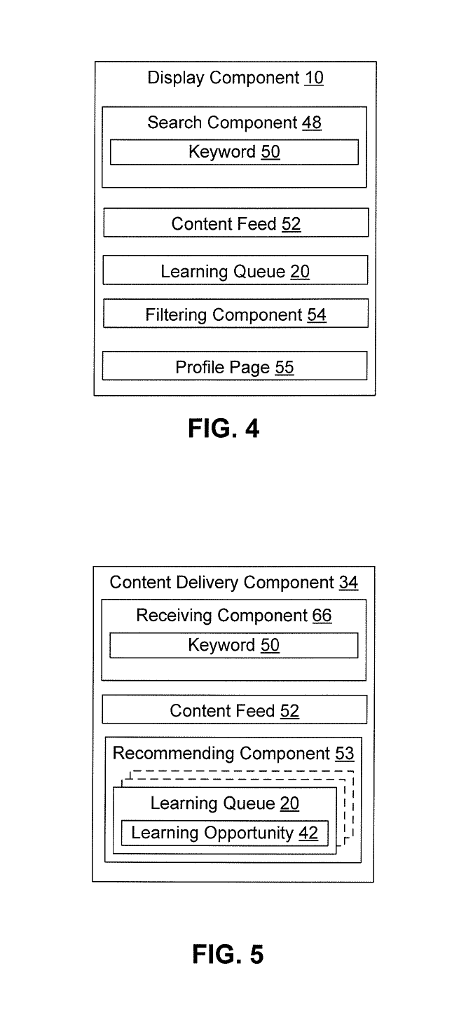

Referring now to FIG. 1, device 102 may include a display component 10 for receiving from server 106 various search options for a user of device 102. Such search options may be used to search for learning opportunities and the search options may be presented to a user of device 102. Display component 10 may also present the received search results from server 106 to a user of device 102. Display component 10 may include a search component 48 (FIG. 4) for presenting search options for a user of device 102, thereby allowing the user to search for a learning opportunity and to receive a search request from the user. In an aspect, search component 48 may receive one or more keywords 50 from the user to use when searching for a learning opportunity. For example, if a user is searching for guitar classes, the user may enter “guitar” as the search input. In another aspect, search component 48 may automatically associated keywords based upon the input received from the user. For example, if a user selects an image presented by display component 10 as input for a search, search component 48 may automatically associate keywords with the selected image. Search component 48 may transmit the search request and any associated key words to server 106.

Server 106 may include a content delivery component 34 that receives the search request from device 102 and generates a content feed 52 with the search results. Content delivery component 34 may have a receiving component 66 (FIG. 5) operable to receive the search request from device 102, along with any keywords 50 (FIG. 5) that may have been transmitted with the search request. Content delivery component 34 may interface with the content manager component 32 and retrieve one or more learning opportunities 42 from content data store 62 (FIG. 2) that correspond to the search request. In an aspect, content delivery component 34 may retrieve one or more learning opportunities 42 from content data store 62 that correspond to keyword 50.

Content delivery component 34 may generate a content feed 52, with the retrieved learning opportunities, from content data store 62. Content feed 52 may include, but is not limited to, a plurality of learning opportunities, learning information associated with the learning opportunities, and source IDs. Content feed 52 may be dynamically updated as new content is received by content manager component 32. In addition, content feed 52 may be updated with recommendations for content. As such, content feed 52 may be a dynamic flowing feed of content that changes as new content and new search requests are received. Content delivery component 34 may transmit content feed 52 to device 102 for presentation.

In an aspect, content delivery component 34 may also include a recommending component 53 that generates and transmits one or more learning queues 20, based on the received search request. Learning queues 20 may include a plurality of learning opportunities 42 associated with a keyword, topic, or category, for example. Recommending component 53 may receive recommended learning opportunities from content manager component 32 based on the received search request. For example, if a user enters as keywords “guitar lessons” in a search request, in addition to providing courses on guitar lessons, recommending component 53 may also provide other courses on writing music and the history of music. Recommending component 53 may aggregate the recommended learning opportunities into one or more learning queues 20 and transmit the learning queues 20 to device 102 for presentation.

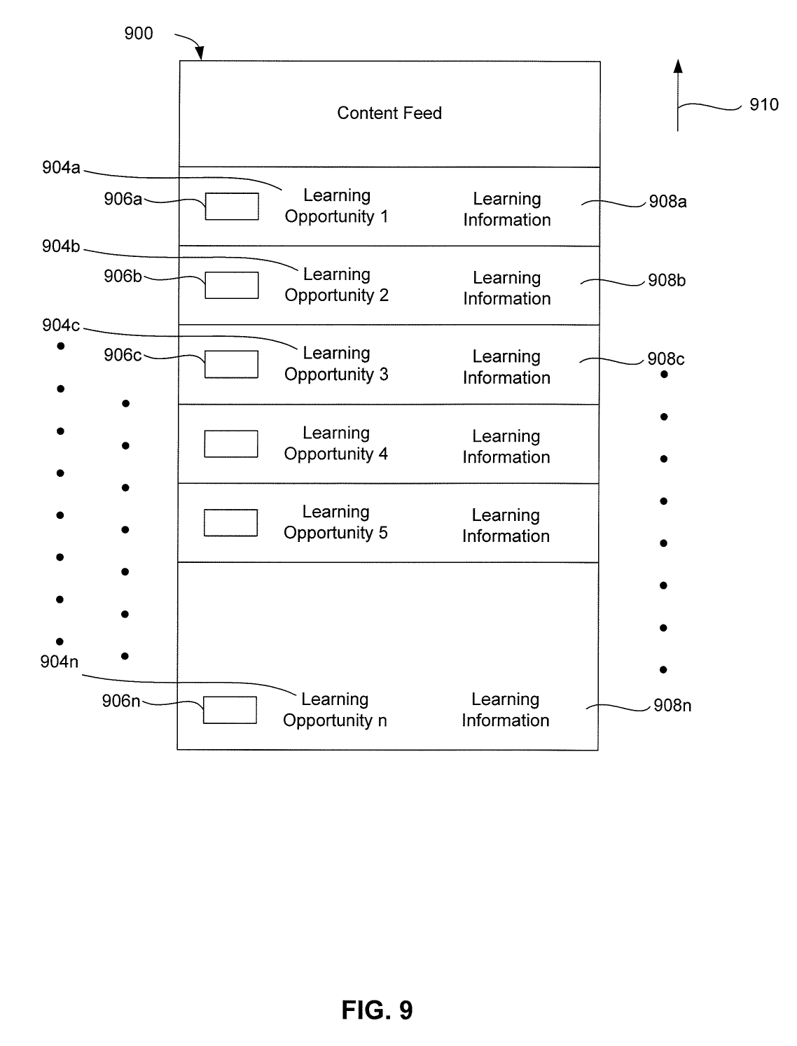

Display component 10 may receive and present content feed 52 to a user of device 102. Referring now to FIG. 9, illustrated therein is an example content feed 900 in accordance with an aspect the present invention. Content feed 900 may include a plurality of learning opportunities 904a-904n and learning information 908a-908n corresponding to a respective learning opportunities 904a-904n. In addition, content feed 900 may include source information 906a-906n for each learning opportunity 904a-904n. In an aspect, content feed 900 may move in an upwards direction 910, as shown in FIG. 9, and dynamically change and update with the addition of new content and/or the removal of content from the content feed.

Referring again to FIG. 1, display component 10 may also receive and present one or more learning queues 20. Display component 10 may include a filtering component 54, through which a user may filter the content displayed in the content feed 52 and/or the learning opportunities displayed in learning queue 20. For example, a user may filter the content displayed in the content feed by a variety of parameters. Parameters may include, but are not limited to, course category (e.g. cooking), skill level, learning mode (e.g., in person, online, audio, video, interactive, multi-session, podcasts, webisode), accreditation information, location information, time information (e.g., mornings, afternoons, evenings), cost, languages, provider information, ratings and reviews, and instructor ranking, etc.

Display component 10 may interface with a selection component 12 to receive a selection of a learning opportunity 14 from a user of device 102. In an aspect, selecting a learning opportunity 14 may include, for example, selecting to take a course provided by the provider 110 of the learning opportunity 14. For example, if the learning opportunity is an online class on how to play the guitar, the user may select to take the online class. In another aspect, selecting a learning opportunity 14 may include adding the learning opportunity 14 to a learning queue 20 to store the learning opportunity 14, so that a user may take the learning opportunity 14 at a later time.

Selection component 12 may interface with learning queue component 18 so that the selected learning opportunities 14 may be placed in one or more learning queues 20. Learning queue component 18 may allow a user to create a learning queue 20. For example, when selecting a learning opportunity, a user may create a new learning queue 20 for the learning opportunity. In another example, a user may add a selected learning opportunity to a preexisting learning queue 20. Learning queue component 18 may also allow a user modify learning queues 20. For example, a user may add and/or remove learning opportunities from a learning queue 20. A user may also move learning opportunities to a different learning queue 20. In addition, learning queue component 18 may allow a user to provide a status of a learning opportunity 14 within the learning queue 20. For example, a user may mark a learning opportunity 14 as complete upon completing the learning opportunity 14. In another example, the learning queue component 18 may determine that a user stopped watching a video and may automatically mark the learning opportunity 14 as in progress (or the user may select to so mark the video).

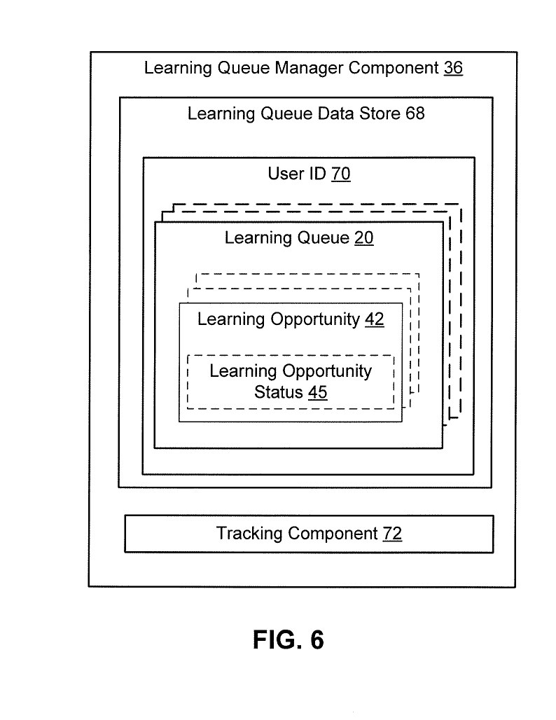

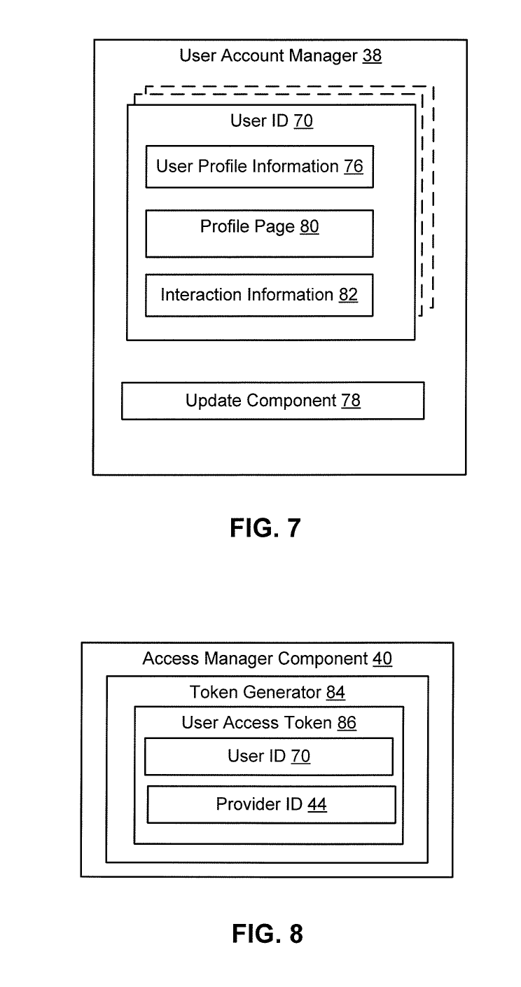

Learning queue component 18 may transmit the learning queues 20 received and/or created by a user of device 102 to learning queue manager component 36 on server 106. Learning queue manager component 36 may include a learning queue data store 68 (FIG. 6) for storing the learning queues 20 associated with a user. For example, learning queue data store 68 may store for each user ID 70 (FIG. 6), the user's learning queues 20. In addition, learning queue data store 68 may store a learning opportunity status 45 associated with the learning opportunity status 42. The status of the learning opportunity 42 may include, but is not limited to, completed, in progress, not started, or canceled. Learning queue manager component 36 may include a tracking component 72, for example, that receives status updates for each learning opportunity 42 and updates the status of the learning opportunity 42. As such, learning queue manager component 36 may manage and store the learning queues for each user using platform 108.

Learning queue manager component 36 may interface with content delivery component 34 and transmit the one or more learning queues 20 stored for the user associated with device 102 for presentation on device 102. Device 102 may also include a sharing component 22 for sharing information with other individuals. In addition, sharing component 22 may be used to share one or more learning queues 20 a user has created with various learning opportunities. In an aspect, sharing component 22 may share information using social media networks, email and/or on blogs, such that users may promote knowledge they are interested in learning about and/or learning opportunities each user likes.

Device 102 may also include a feedback component 26, so a user may provide ratings and reviews about a learning opportunity 14, one or more learning queues 20, and/or instructors, for example. Ratings may include, but are not limited to, number of stars, numeric ratings, or text summarizing data relating to the quality of the courses and/or performance of the instructors, as well as any other suitable information relating to a decision to purchase a course. Positive feedback, such as “great instructor,” may encourage other users with similar interests to purchase the class. Negative feedback, such as “did not enjoy the class,” may discourage other users with the similar interests from purchasing the class. Thus, feedback component 26 may be used to distribute reviews and ratings to other users of the platform 108 or other individuals in the user's social network to help promote and/or market learning opportunities, and may also be used for other purposes (e.g., to assist instructors with feedback/competition).

Device 102 may also include location component 24 for providing a current location of device 102. For example, location component 24 may include a Global Positioning System (GPS) module that indicates the location of device 102.

Device 102 may also include a profile manager component 28 for managing profile information 30 of a user of device 102. Profile information may include, but is not limited to, a user's name, city of residence, interests, individuals the user is following, ratings and reviews, and courses the user has taught. Profile manager component 28 may allow a user to update and modify the user's profile information 30. Profile manager component 28 may transmit the received profile information 30 to platform 108.

Platform 108 may include a user account manager component 38 for managing the user accounts for the users of platform 108. User account manager component 38 may store for each user ID 70, for example, user profile information 76, and interaction information 82. Interaction information may include, but is not limited to, information about individuals the user is following (e.g., whether the user following other individual's queues or topic pages) and information about what the user is sharing with other individuals. In an aspect, interaction information may include an engagement score based on what information a user is viewing and/or sharing. For example, the user may receive 2 points for expanding a course to view additional information, 4 points for adding the course to the queue, 4 points for visiting the provider page and viewing the course, and 6 points for sharing the course with another individual. The engagement score may be used to determine how active a user is in the system. In addition, user account manager component 38 may include an update component 78 for updating and/or modifying the user information.

In an aspect, a user of device 102 may decide to take a learning opportunity 42 (e.g., a class offered by provider 110). Selection component 12 on device 102 may be used to transmit the selected learning opportunity 14 and the provider ID 16 to server 106 for processing. Server 106 may interface with provider 110 to facilitate the user accessing the learning opportunity from provider 110.

In another aspect, selection component 12 may interface directly with provider 110. Provider 110 may include an authentication component 46 for verifying whether the user may take the learning opportunity from provider 110. Authentication component 46 may interface with an access manager component 41 on sever 106 to verify that a user may access the learning opportunity from provider 110. For example, authentication component 46 may transmit an authorization request to access manager component 41 requesting whether the user is authorized to access the learning opportunity from provider 110.

Access manager component 41 may include a token generator component 84 (FIG. 8) that generates a user access token 86 (FIG. 8) associated with a user ID 70 and a provider ID 44. Access manager component 41 may receive an authorization request from authentication component 46 and generate an access token 86 in response to the authorization request. In another aspect, access manager component 41 may receive a selection from device 102 and generate an access token 86 in response to the selection. Access manager component 41 may transmit the user access token 86 to authentication component 46 so that the user may access the selected learning opportunity 42 provided by provider 110.

In an aspect, server 106 may also facilitate payment for the selected learning opportunity. For example, platform 108 may also include a payment manager component 40 for facilitating the payment of the selected learning opportunity. Payment manager component 40 may receive a payment request from provider 110 after provider 110 authenticates that the user may access the learning opportunity provided by provider 110. Payment manager component 40 may store an account balance for each user of the system and may deduct the appropriate amount of money from the account balance to facilitate payment of the learning opportunity. Payment manager component 40 may transmit the appropriate amount of money to provider 110 to pay for the selected course. In an aspect, payment manager component 40 may send a message to a user of device 102 that enables the user to confirm that the user would like to purchase the learning opportunity. Thus, a user may maintain a central account balance that may be used to easily pay for selected courses without the user having to manage the payment for each course or establish a trust relationship with the provider of the course, which may include, for example, providing credit card information or establishing another form of payment with the provider.

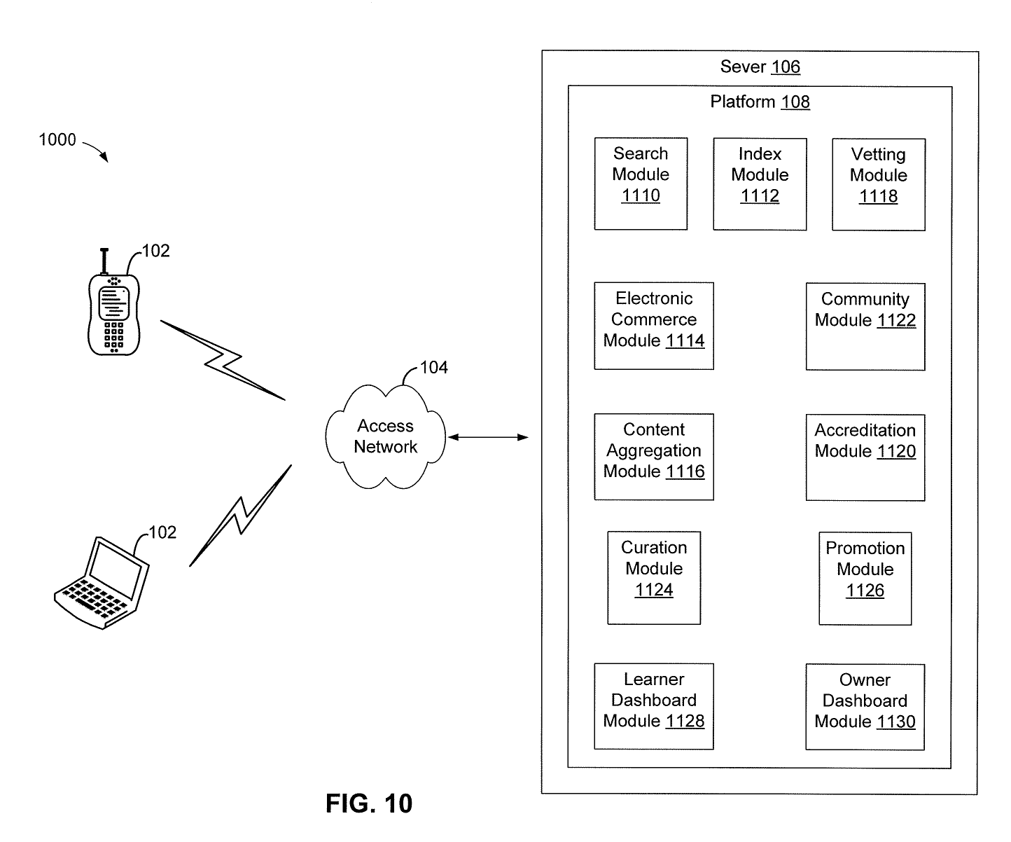

Referring now to FIG. 10, illustrated is a system 1000 that may be used to facilitate online knowledge transfers in accordance with aspects of the present invention. System 1000 may include a server/computer 106 in communication with one or more devices 102 via an access network 104.

Platform 108 may include a plurality of modules, such as, but not limited to, search module 1110 for performing searches for learning opportunities, index module 1112 for storing and indexing learning opportunities, electronic commerce module 1114 for enabling the buying and selling of learning opportunities, content aggregation module 1116 for aggregating content, vetting module 1118 for vetting buyers and sellers of learning opportunities, accreditation module 1120 for providing accreditation for instructors, community module 1122 for sharing learning opportunities and facilitating communication among knowledge seekers and/or knowledge owners, curation module 1124 for curating learning opportunities, promotion module 1126 for promoting learning opportunities and/or instructors, learner dashboard module 1128 for tracking courses that are pending and/or have been taken by the learner, and owner dashboard module 1130 for enabling courses offered by a knowledge owner to be listed in the system. It should be noted that platform 108 may sync activity across devices 102 and knowledge owner dashboard module 1130 to enable courses to be listed in the system.

In an aspect, search module 1110 may receive a search request from device 102 for a learning opportunity. Search module 1110 may perform, for example, a vertical search across a plurality of resources to identify learning opportunities that correspond to the requested learning opportunity. In addition, search module 1110 may filter the search results based, for example, upon one or more received parameters for the learning opportunity. Parameters for learning opportunities may include, but are not limited to, course category (e.g. cooking), skill level, learning mode (e.g., in person, online, audio, video, podcasts, webisode), location information, time information (e.g., mornings, afternoons, evenings), cost, and instructor ranking, etc.

In an aspect, vetting module 1118 and community module 1122 may allow users of platform 108 to provide ratings and reviews of courses and/or instructors. Ratings may include, but are not limited to, numbers of stars, numeric ratings, or text summarizing data relating to the quality of the courses and/or performance of the instructors, as well as any other information relating to a decision to purchase a course. This data may be used as an input into vetting module 1118 to rate and vet instructors.

Positive feedback, such as “great instructor,” may encourage other users with similar interests to purchase the class, while negative feedback, such as “did not enjoy the class,” may discourage other users with the similar interests from purchasing the class. Thus, community module 1122 may be used to distribute reviews and ratings to other users of the platform 108 to help promote and/or market learning opportunities.

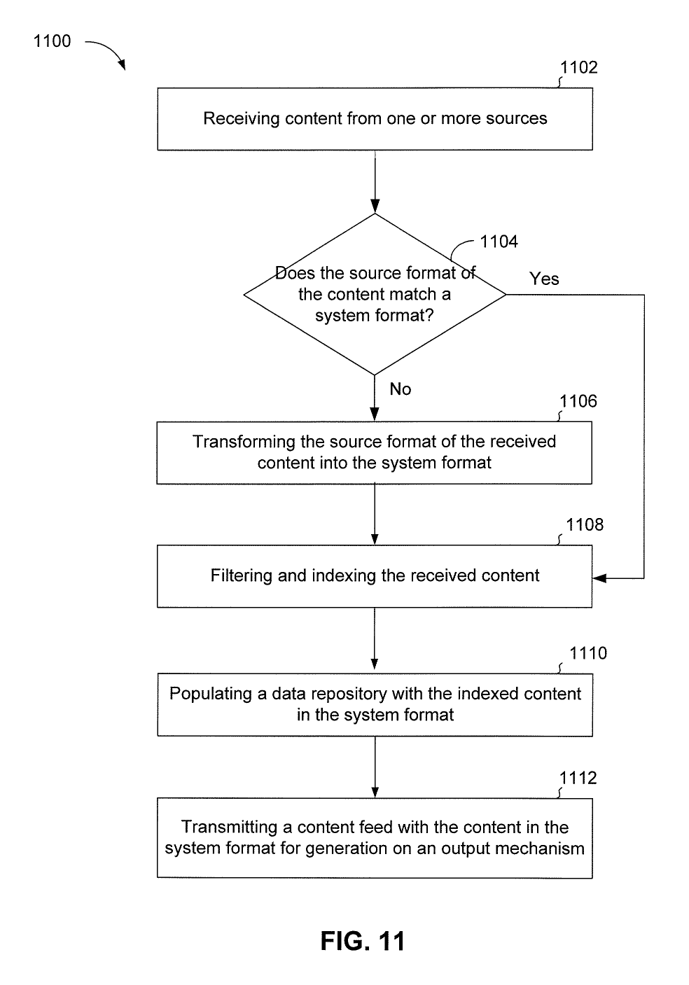

Referring now to FIG. 11, illustrated therein is an example method flow 1100 for normalizing data in accordance with an aspect of the present invention. The method may include receiving content from one or more sources 1102. Content may include, for example, learning opportunities, such as classes for professional development and/or learning a new skill, hobby, or sport. In addition, content may include, for example, learning information. Learning information may include, but is not limited to, provider information (e.g., name of the provider, overview of the provider, ratings of the provider, experience of the provider), class name, class overview information, a preview of the class, class times, class ratings, level of difficulty for the class, class language information, instructor information, instructor rating, price, class location, modality for the class, accreditation information (e.g., college credit, certifications, and transcripts), keywords associated with the class, prerequisites for the class, etc. In an aspect, server 106 (FIG. 1) may have a retrieving component 56 (FIG. 2) to retrieve content from a plurality of sources, such as providers 110 (FIG. 1). For example, the server may send a crawler out to the various sources and retrieve content provided by the sources. The content may be retrieved, for example, through an API feed from the providers, JSON, HTML and XML content of the providers, RSS feeds, and Atom language programming, for example.

The method may also include determining whether the source format of the content matches a system format. Each of the various sources may provide the content in a different format. In an aspect, server 106 may have a parser component 58 (FIG. 2) that determines whether the source format of the content matches a system format.

When the source format of the content does not match the system format, the method may include transforming the source format of the received content to the system format 1106. For example, parser component 58 may manipulate the source format of the content into the system format. By transforming the source formats into a common system format, the content may be easily manipulated and/or searched. In addition, the content may be presented in a uniform manner so that users can easily identify the learning opportunities and the learning information.

The method may also include filtering and indexing the received content 1108. When the source format of the received content does match the system format, the method may proceed to 1108. For example, indexing the received content may include, but is not limited to, associating keywords, categories, images, content providers, skill levels, learning mode (e.g., in person, online, audio, video, webisode), location information, time information (e.g., mornings, afternoons, evenings), cost, and instructor ranking, with the content received. In an aspect, index component 60 (FIG. 2) may aggregate and organize the received content based on, for example, provider IDs and metadata associated with the content. In addition, index component 60 may map the received content to index fields for more efficient searches.

In addition, the method may include populating a data repository with the indexed content in the system format 1110. In an aspect, server 106 may include a content data store 62 (FIG. 2) that stores the indexed content so that the content may be easily searched and identified.

The method may also include transmitting a content feed in the system format, for generation on an output mechanism. The content feed may include, for example, a plurality of learning opportunities, learning information associated with the learning opportunities, and source IDs. For example, server 106 may have a content delivery component 34 (FIG. 1) that transmits the content feed to device 102 (FIG. 1) for presentation on device 102.

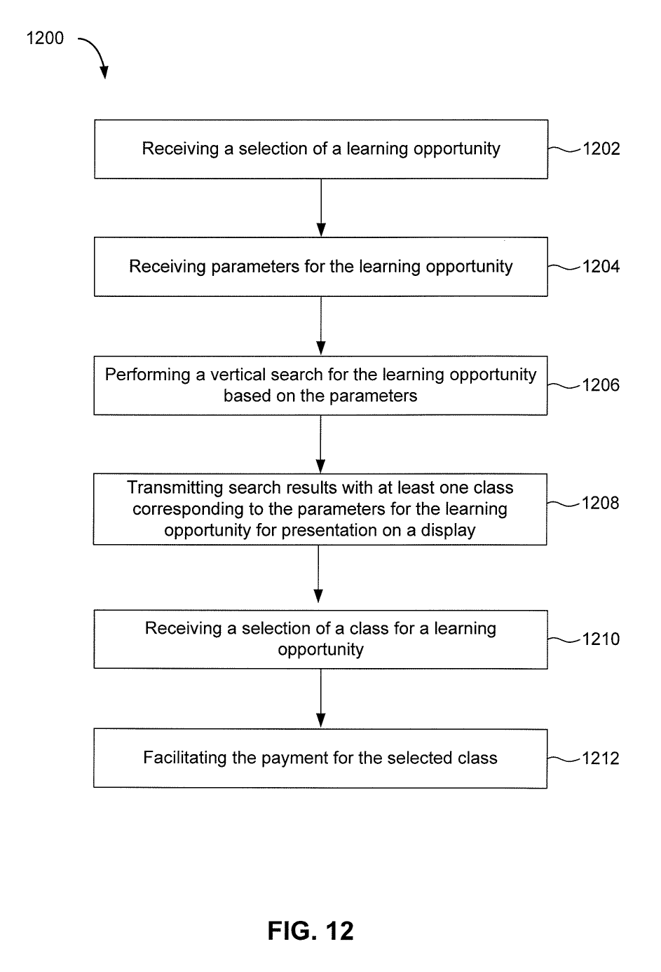

Referring now to FIG. 12, illustrated is an example method flow 1200 for searching for a learning opportunity in accordance with an aspect of the present invention. The method may include receiving a selection of a learning opportunity 1202. Learning opportunities may include, for example, classes for professional development and/or learning a new skill, hobby, sport, etc.

The method may also include receiving parameters for the learning opportunity 1204. Parameters may include, but are not limited to, skill level, learning mode (e.g., in person, online, audio, video, webisode), location information, time information (e.g., mornings, afternoons, evenings), cost, and instructor ranking, among other parameters for the learning opportunity. In an aspect, the platform may receive input from the user indicating the parameters for the learning opportunity. For example, the user may input parameters using a drop down menu, moving a slider from a first point to a second point (e.g., from a high price to a lower price), drawing a circle to include various parameters (e.g., drawing a circle around a regional area), or inputting text to indicate the parameters for the learning opportunity, among other user interface mechanisms for inputting information.

In addition and/or alternatively, the server may automatically determine the parameters for the learning opportunity based upon one or more received inputs from a device of the user. For example, platform 108 (FIG. 1) may receive location information, such as latitude and longitude coordinates from a GPS module on device 102 (FIG. 1) that indicates the location of device 102. Platform 108 may automatically set a radius (e.g., 10 miles) around the received location information as the location information for the learning opportunity. In another example, platform 108 may automatically determine times when the user may be available for the learning opportunity. For example, platform 108 may receive calendar information from a calendar component on device 102. Platform 108 may determine when a user of device 102 may be available for a learning opportunity based upon time period(s) that are free in the calendar. It should be noted that the user may provide a set of rules that the platform may use when automatically determining the parameters for the learning opportunity based upon received information from the device.

In addition, the method may include performing a vertical search for the learning opportunity based on the parameters 1206. For example, the platform may perform a search for learning opportunities across multiple websites and data repositories that provide learning opportunities. Thus, the platform may consolidate fragmented online learning opportunities into a single search result. Moreover, the platform may filter the search results based upon the parameters for the learning opportunity. For example, if the user provides a parameter of in person classes, the platform may filter and/or remove from the search results classes that are only offered online or through a video.

The method may further include transmitting search results with at least one class corresponding to the parameters for the learning opportunity for presentation on a display 1208. For example, the platform may transmit the search results for presentation on a display of a device. In an aspect, the search results may be presented on a map with the various search results illustrated on the map, for example, by a circle or other icon. In addition, one or more of the following information may be presented for each class included in the search results: class name, class times, instructor information, instructor rating, price, class location, modality for the class, etc.

The method may include receiving a selection of a class for a learning opportunity 1210. For example, the platform may receive a selection of a class for a search result from device 102. It should be noted that the platform may receive a plurality of selected classes for each user. Thus, the platform may have a user account that tracks the selected classes by each user. In an aspect, the user may access the user account to calculate the number of classes that a user may have taken.

The method may also include facilitating payment for the selected class 1212. For example, the platform may automatically deduct a payment for the selected class from the user account of the individual who selected to purchase the class and automatically provide the received payment to the user account of the instructor of the selected class. In an aspect, the platform may receive a percentage of a payment for each class for which the platform helps to facilitate the payment of the transaction. In addition, when the class is free of charge, the provider of the class may also provide a payment to the platform for helping to facilitate the transfer of knowledge between the individual who selected to take the course and the provider of the course.

Thus, the platform may thereby create a marketplace to facilitate the online transfer of knowledge and may facilitate the payment for the transfer of knowledge all within a single location.

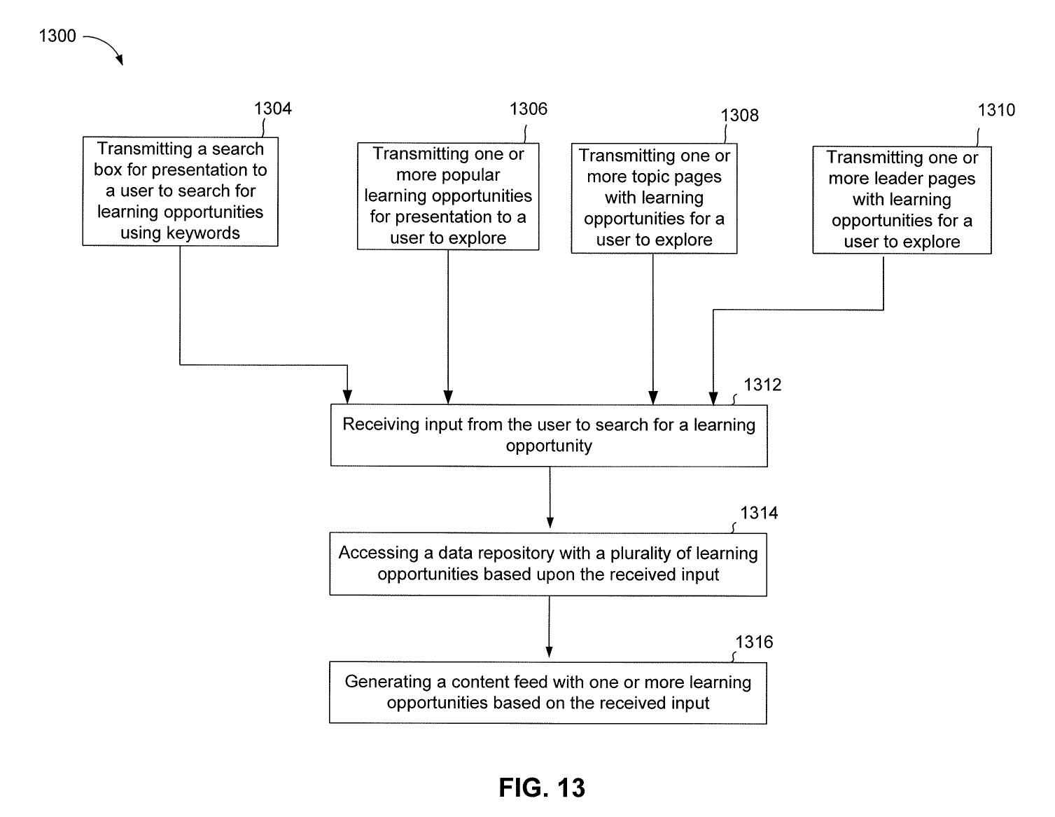

Referring now to FIG. 13, illustrated therein is an example method flow 1300 for searching for a learning opportunity in accordance with an aspect of the present invention. The method may include transmitting a search box for presentation to a user to search for learning opportunities using keywords 1304. For example, a user may have a specific type of learning opportunity the user is looking for, so that the user may enter a keyword to search for the learning opportunity. In an aspect, device 102 (FIG. 1) may have a display component 10 (FIG. 1) that receives the search box from server 106. In addition, device 102 may have a selection component 12 (FIG. 1) that receives a user's keyword search for a learning opportunity and transmits the search to server 106.

The method may also include transmitting one or more popular learning opportunities for presentation to a user to explore 1306. Popular learning opportunities may include, but are not limited to, classes that a large number of users are taking and classes with keywords that are used frequently. In addition, popular learning opportunities may span a variety of topics and interests. As such, a user may be able to receive a variety of popular learning opportunities to explore. For example, server 106 may determine which learning opportunities may be a popular and display component 10 may receive the popular learning opportunities from server 106 for a user to explore.

The method may include transmitting one or more topic pages with learning opportunities for presentation to a user to explore 1308. Topic pages may include curated courses for a particular topic. Topics may include, but are not limited to, Art and Design, Business, Crafts and Hobbies, Education, Fitness and Health, Food and Drink, How To's, Humanities, and Language, among other topics. Topic pages may include seasonal components or learning opportunities associated with current events. Users may select all of the learning opportunities presented on a topic page or a subset of the learning opportunities presented on the topic page. Topic pages may also include images of influencers for a specific topic and lifestyle related images for the specific topic. In an aspect, the images may be associated with keywords that correspond to courses so that when a user selects an image, the corresponding courses may be retrieved.

In an aspect, server 106 may automatically populate topic pages with learning opportunities based, for example, on keywords, categories, reviews of courses, and density (e.g., number of individuals that have taken the courses). In another aspect, an individual may curate courses for a particular topic and transmit the curated topic pages to the server for storage.

The method may also include transmitting one or more leader pages with learning opportunities for presentation to a user to explore 1310. Leader pages may include pages that individuals prominent in an area have curated. For example, leader pages may include queues of courses and topics that the leader may be interested in taking and/or may have taken. The leader pages may be shared with other users of the system and/or may be followed by the users. As the leader adds, removes, and/or completes courses, other users of the system may be notified. Users may be able to follow all the queues the leader established or a portion of the queues that the leader established. In an aspect, display component 10 may receive one or more leader pages from server 106 to present to a user of device 102.

In an optional aspect, the method may include transmitting to a user a random search option so that a user may select a random learning opportunity. For example, the user may want to be surprised with learning opportunities, in which case, the user may select the “random” option. In addition, the user may want to explore new topics or courses to take, in which case, the user may also select the random option, in order to receive information on new topics.

The method may also include receiving input from the user to search for a learning opportunity 1312. In an aspect, selection component 12 may receive input from a user for searching for a learning opportunity, and transmit the received input to server 106 for processing. The input may include selecting, for example, a keyword search, a popular learning opportunity, an image from a topic page, a learning opportunity from a topic page, a learning opportunity from a leader page, and/or a random search option.

The method may additionally include accessing a data repository with a plurality of learning opportunities based on the received input 1314. For example, server 106 may receive the search input from device 102 and access the content data store 62 (FIG. 2) to search for the requested learning opportunities.

The method may further include generating a content feed with one or more learning opportunities based on the received input 1316. In an aspect, content delivery component 34 (FIG. 1) may generate a content feed with the retrieved learning opportunities from content data store 62, and transmit the content feed to device 102 for display. In an aspect, the content feed may dynamically change based on individuals that a user may be following. For example, as individuals add and/or remove content from the individuals' pages, the content feed may dynamically change to reflect the changes.

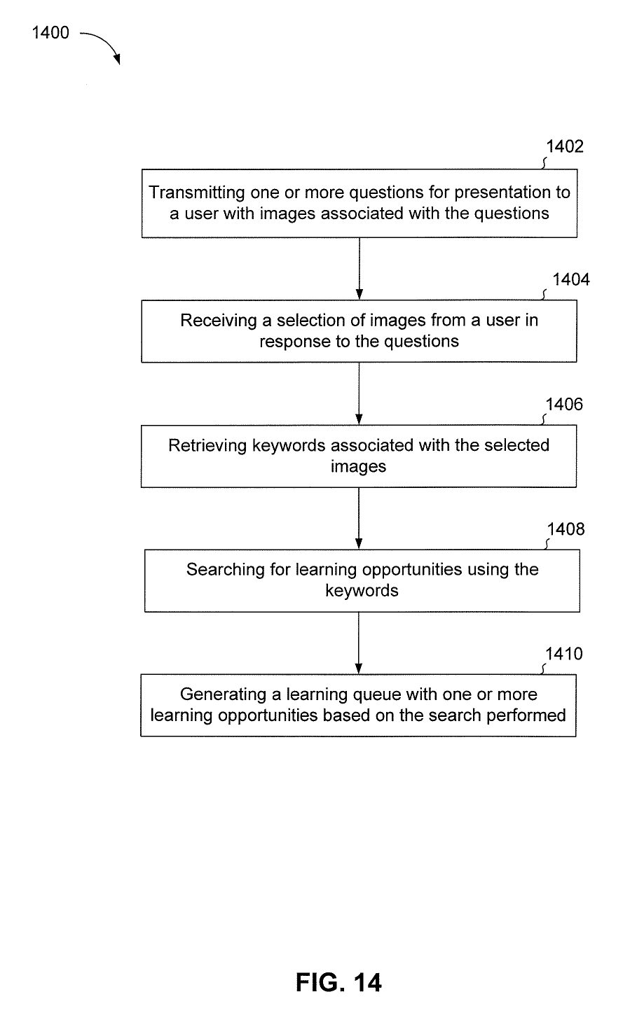

Referring now to FIG. 14, illustrated therein is an example method flow 1400 for searching for a learning opportunity in accordance with an aspect of the present invention. The method may include transmitting one or more questions for presentation to a user, along with images associated with the questions 1402. The questions may be used, for example, to determine what interests a user may have, and may also involve presenting various images that the user may select in response to the questions. For example, the questions may ask the user what type of job the user would prefer doing and present images of three different types of jobs the user may select. In an aspect, six questions may be presented to the user with three images that a user may select in response to each of the questions. It should be noted that any number of questions and images may be presented to the user. In addition, the questions presented may differ each time a user chooses to answer the questions. Thus, a user may receive different recommendations for learning opportunities each time the user answers the questions. To accomplish this result, for example, device 102 (FIG. 1) may receive one or more questions from server 106 to present to a user of device 102.

The method may also include receiving a selection of images from a user in response to the questions 1404. For example, device 102 may have a selection component 12 (FIG. 1) that receives a selection of images from a user and transmits the selected images to server 106.

In addition, the method may include retrieving keywords associated with the selected images 1406. Each image presented to a user may be associated with keywords that may correspond to one or more learning opportunities. For example, an image of an astronaut may have keywords, such as science and exploration, associated with the image. In an aspect, the keywords may be predetermined in advance for each image, such as through natural language processing. For example, server 106 may retrieve the keywords associated with the selected images.

The method may also include searching for learning opportunities using the keywords 1408. In an aspect, server 106 may access the content data store 62 and retrieve one or more learning opportunities associated with the keywords. It should be appreciated that a variety of learning opportunities may be selected based on the keywords.

The method may further include generating a learning queue with one or more learning opportunities based on the search performed 1410. For example, server 106 may generate a recommended learning queue with a plurality of learning opportunities based upon the search performed. Thus, a user may receive recommended learning opportunities by providing answers to a few questions about what interests the user.

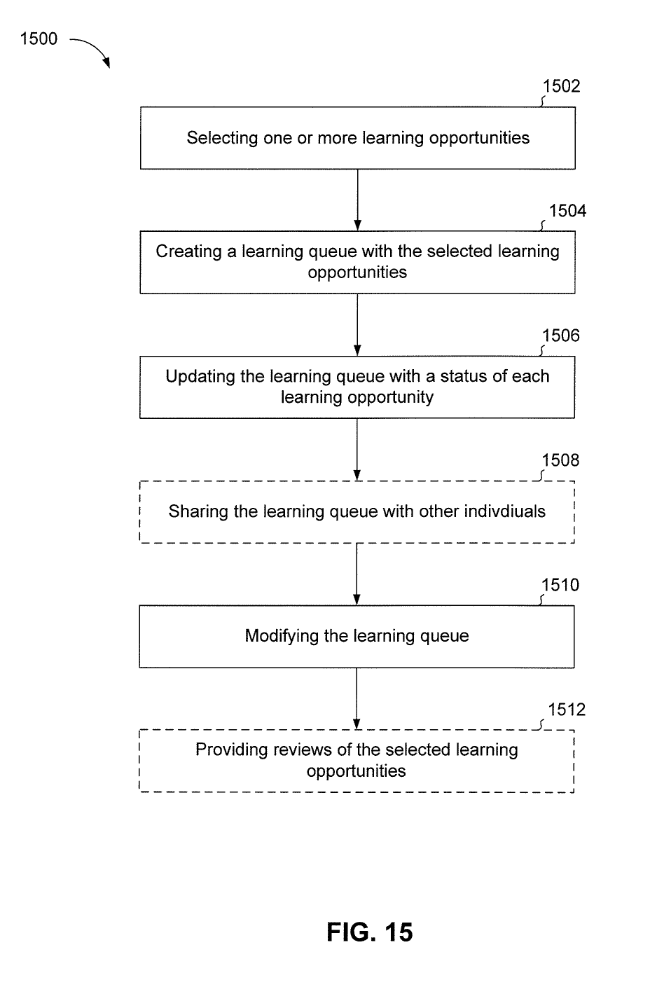

Referring now to FIG. 15, illustrated therein is an example method flow 1500 for managing learning queues in accordance with an aspect of the present invention. The method may include selecting one or more learning opportunities 1502. For example, a user of a device may select learning opportunities from a content feed on the device. In addition, a user of a device may select learning opportunities from queues of other individuals that the user is following. In an aspect, device 102 (FIG. 1) may have a selection component 12 (FIG. 1) that is able to receive the selected learning opportunities.

The method may also include creating a learning queue with the selected learning opportunities 1504. A user may select a learning opportunity to include in a learning queue, for example, by dragging and dropping the learning opportunity into the selected learning queue. The learning opportunities may be automatically added to a learning queue when a user selects another individual's learning queue to duplicate. In addition, a user may highlight a subset of learning opportunities from another individual's queue and create a learning queue with the highlighted learning opportunities. Further, a user may create a learning queue upon selecting the learning opportunity when a learning queue does not already exists or when a user would like to start a new learning queue.

Learning queues may include labels to identify the learning opportunities within the learning queues. Example labels may include Favorites, Music, Photography, Baking, Fitness and Science. A user may select the label for the learning queue upon creation of the learning queue, or the labels may be automatically assigned to the learning queues. As such, a user may have a plurality of learning queues, with one or more learning opportunities included in each learning queue. For example, device 102 may have a learning queue component 18 (FIG. 1) that may create a learning queue with the selected learning opportunities.

The method may additionally include updating the learning queue with a status of each learning opportunity 1506. The learning opportunity status may include, but is not limited to, completed, in progress, not started, or canceled. For example, learning queue component 18 may update the status of the learning opportunity. In an aspect, a user may provide a status of a learning opportunity. For example, a user may mark a learning opportunity as complete upon completing the learning opportunity 14. In addition, the status of the learning opportunity may be automatically determined. For example, when a user stops watching a video for a learning opportunity, a server may determine the stopping place in the video and may update the learning opportunity as in progress based on the point in the video at which the user stopped (e.g., 50% complete). The status of the learning opportunity may by course specific (e.g., how far is a user within a course). In addition, the status of the learning opportunity may also be based upon a number of classes in the learning opportunity (e.g., completed 4 out of 10 classes). As such, a user may be able to view any learning queue and see a status for each learning opportunity within the learning queue.

Optionally, the method may include sharing the learning queue with other individuals 1508. For example, users may share the learning queues with other individuals via, for example, social media networks, email messages, blogs and/or profile pages created using the platform. In an aspect, device 102 may have a sharing component 22 (FIG. 1) for sharing the learning queues.

The method may also include modifying the learning queue 1510. Modifying the learning queue may include, but is not limited to, adding learning opportunities, removing learning opportunities, placing the learning opportunities in an order, and/or changing an order of the learning opportunities. For example, learning queue component 18 may allow a user to modify the learning queues.

In addition, the method may optionally include providing reviews of the selected learning opportunity 1512. Reviews may include ratings, such as, number of stars, numeric ratings, or text summarizing data relating to the quality of the learning opportunity and/or performance of the instructors, as well as any other suitable information relating to a decision to purchase a learning opportunity. In an aspect, device 102 may include a feedback component 26 (FIG. 1) that receives a user's review of the learning opportunity.

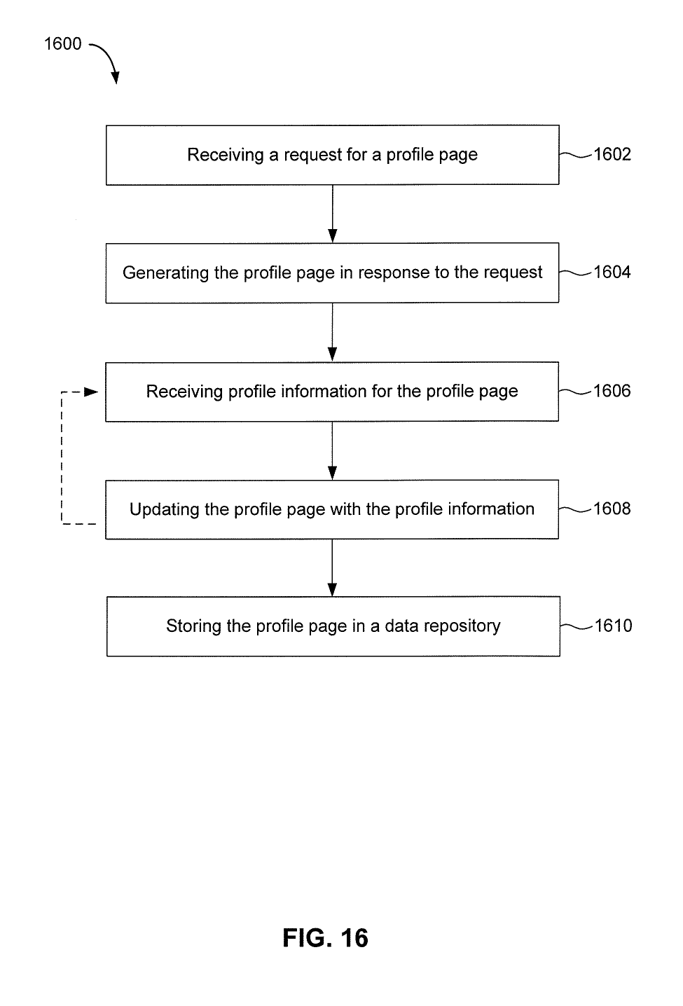

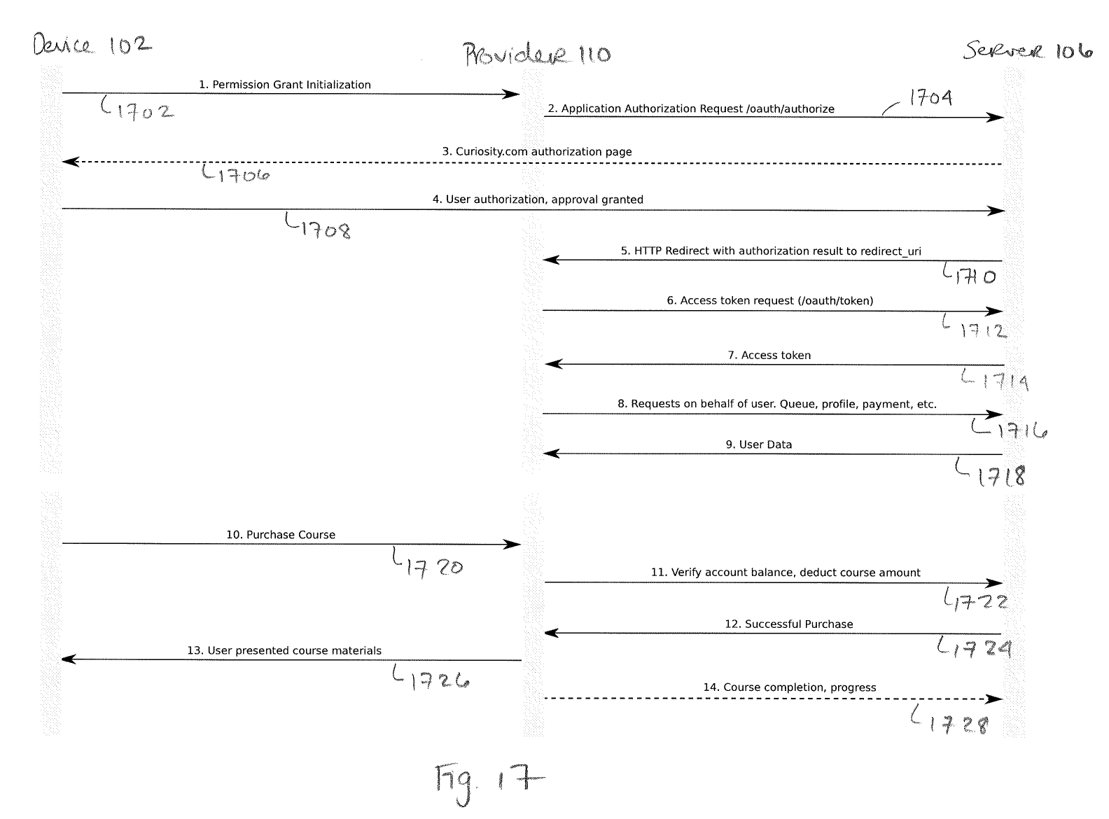

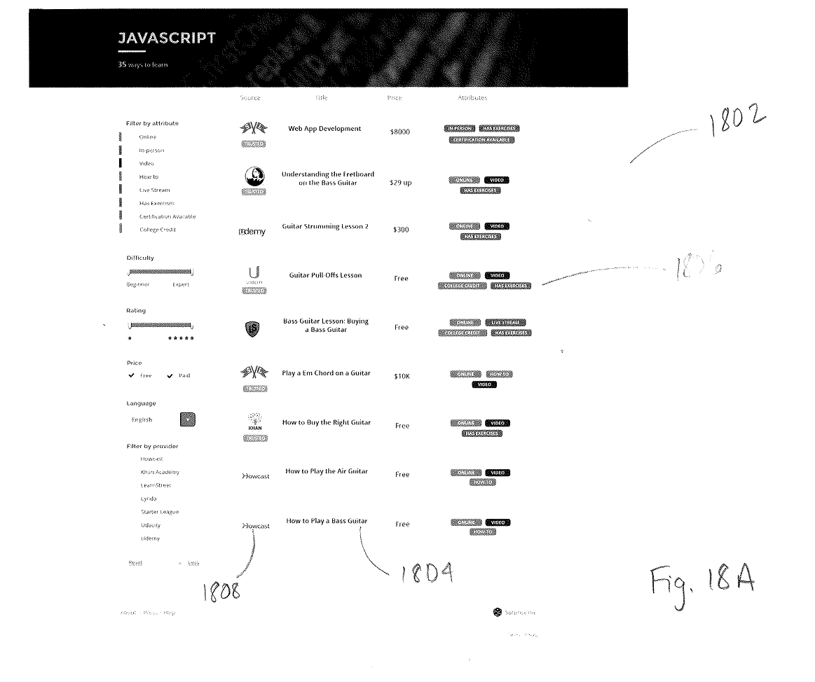

Referring now to FIG. 16, illustrated is an example method flow 1600 for creating a profile page in accordance with an aspect of the present invention. The method may include receiving a request for a profile page 1602. In an aspect, a user may create a profile page to list approved classes that are being taught by the knowledge owner and to share knowledge with other individuals. The user may be able to teach other individuals a particular skill through, for example, a class or instructional video. The user may create a profile page to promote the ability of the user to teach the particular skill. In another aspect, a user may create a profile page with areas of interest.

The method may also include generating the profile page in response to a request 1604. For example, the platform may generate a profile page accessible by the various users of the platform. Thus, the profile pages may be used to create a social environment where information may be shared among users of the platform. For example, the profile pages may be used to share various areas of interests of users and/or skills that that users are willing to share with other users. In addition, the profile pages may be shared using social media networks, email and/or blogs, so that users may promote the knowledge that they may be able to share with others.

The method may further include receiving profile information for the profile page 1606. The user may input profile information by using, for example, a drop down menu or inputting text, among other user interface mechanisms for inputting information.

In addition, the method may include updating the profile page with the profile information 1608. For example, the profile pages may be updated as users add interests, skills, accreditations, images and videos, press clippings, links to websites, etc. It should be noted that the profile pages may be dynamically updated as users add additional information. Profile information may also be auto-populated through the platform with profile updates under user control. Thus, the profile pages may provide the current interests of a user and/or classes that a user is willing to teach.

The method may further include storing the profile page in a data repository 1610. For example, the platform may store and index the created profile pages in a data repository. Thereby, when a user requests a search for a learning opportunity, the platform may access the data repository with the stored profile pages of instructors offering to teach various classes when performing the search.

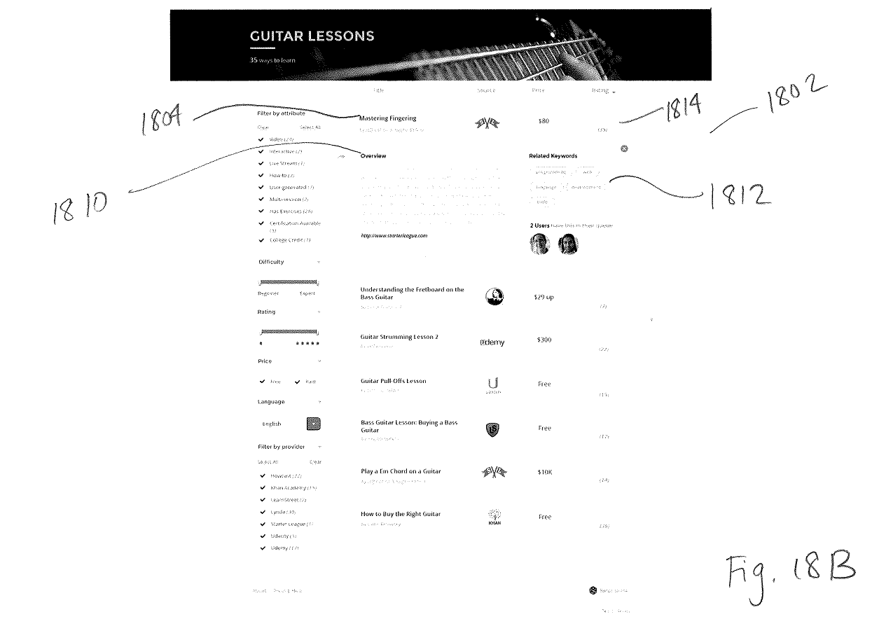

Referring now to FIG. 17, illustrated therein is an example method flow 1700 for facilitating a payment for a learning opportunity in accordance with an aspect the present invention. The method may include, at 1702, provider 110 receiving a permission grant initialization from device 102. At 1704, the method may include server 106 receiving an authorization request from provider 110 in response to receiving a permission grant initialization from device 102. At 1706, the method may include sending an authorization page to device 102, and at 1708, the method may include receiving an approval from device 102.

At 1710, the method may include sending a redirect message with the authorization result to provider 110. Next, at 1712, the method may include receiving an access token request from provider 110 and sending an access token to provider 110 in response to the access token request. The method may also include, at 1716, receiving a request for user data from provider 110. User data may include, for example, user profile information and payment information. At 1718, the method may include sending the user data to provider 110.

Next, at 1720, the method may include receiving a purchase request from device 102 and, at 1722, the method may include receiving a request to verify an account balance for the user. Server 106 may verify that the account balance of the user has sufficient funds to purchase the course and, at 1724, the method may include sending a purchase message to provider 110. At 1726, the method may include transmitting the course materials to device 102 and, at 1728, the method may include receiving a course status update from provider 110.

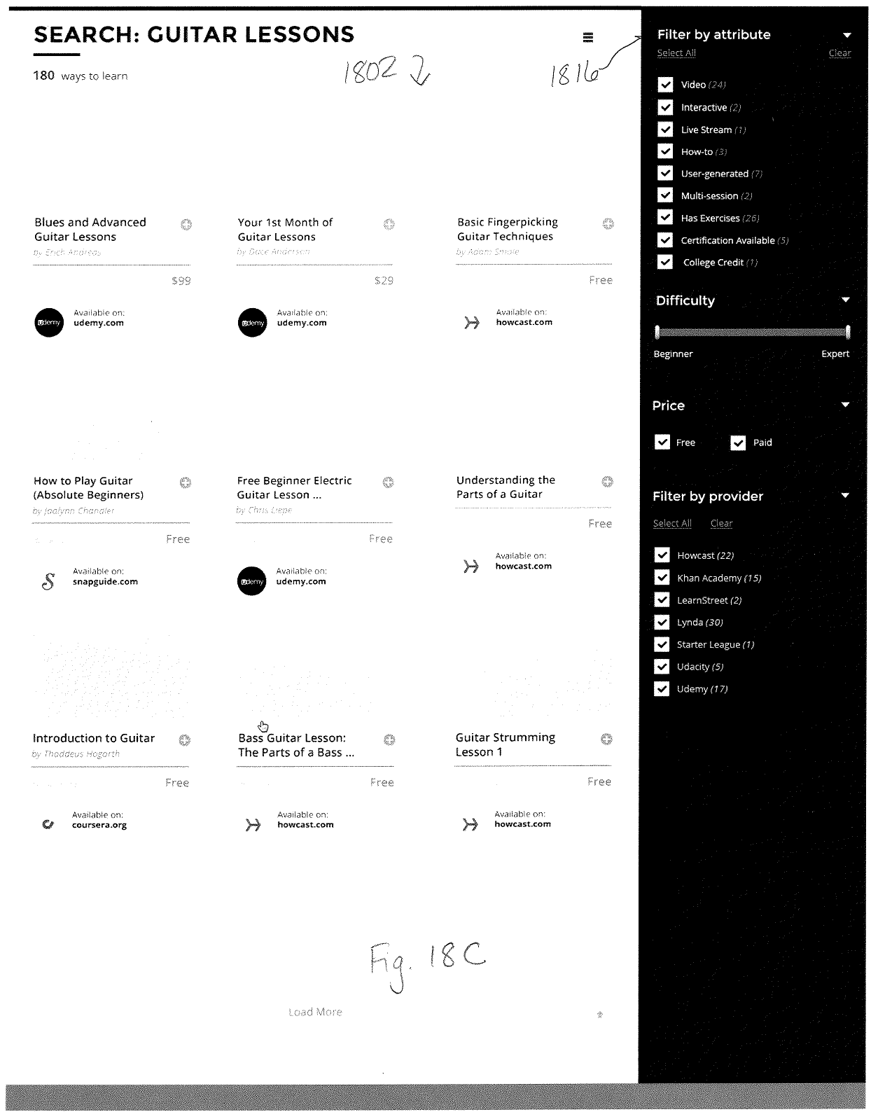

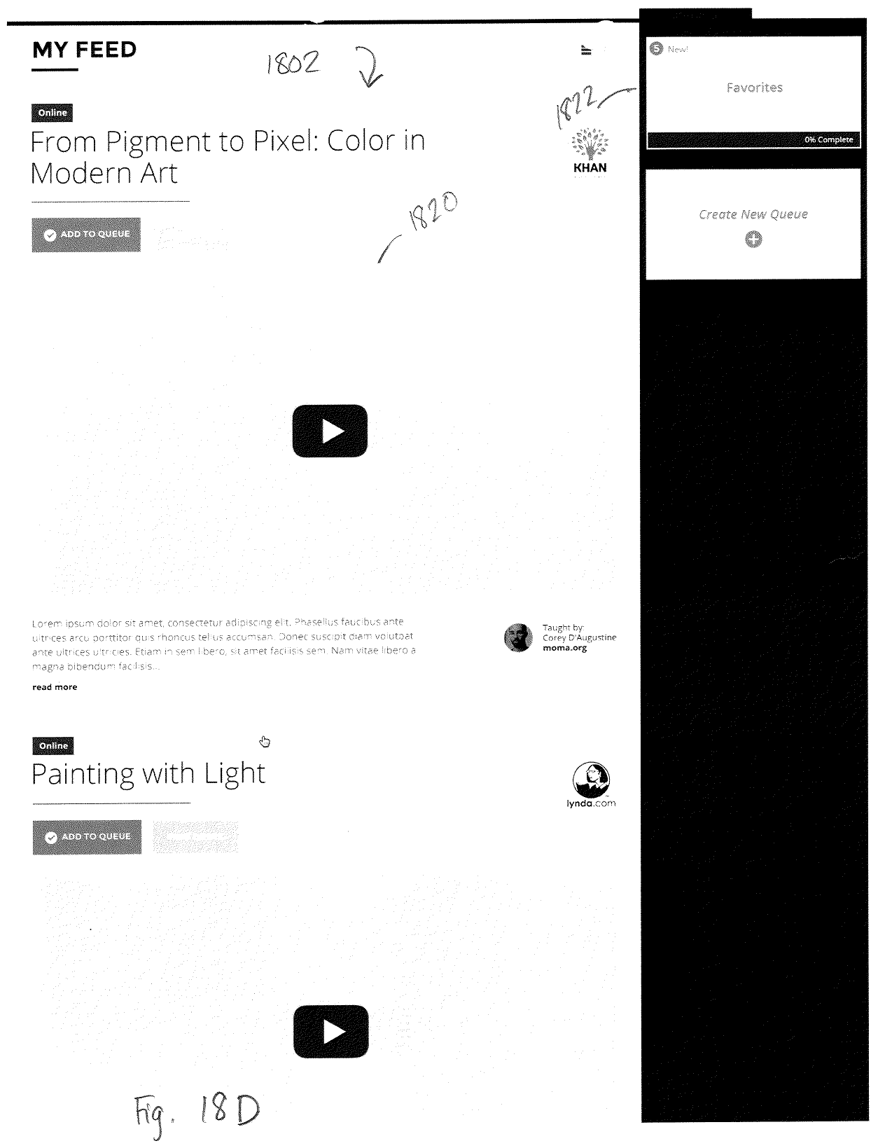

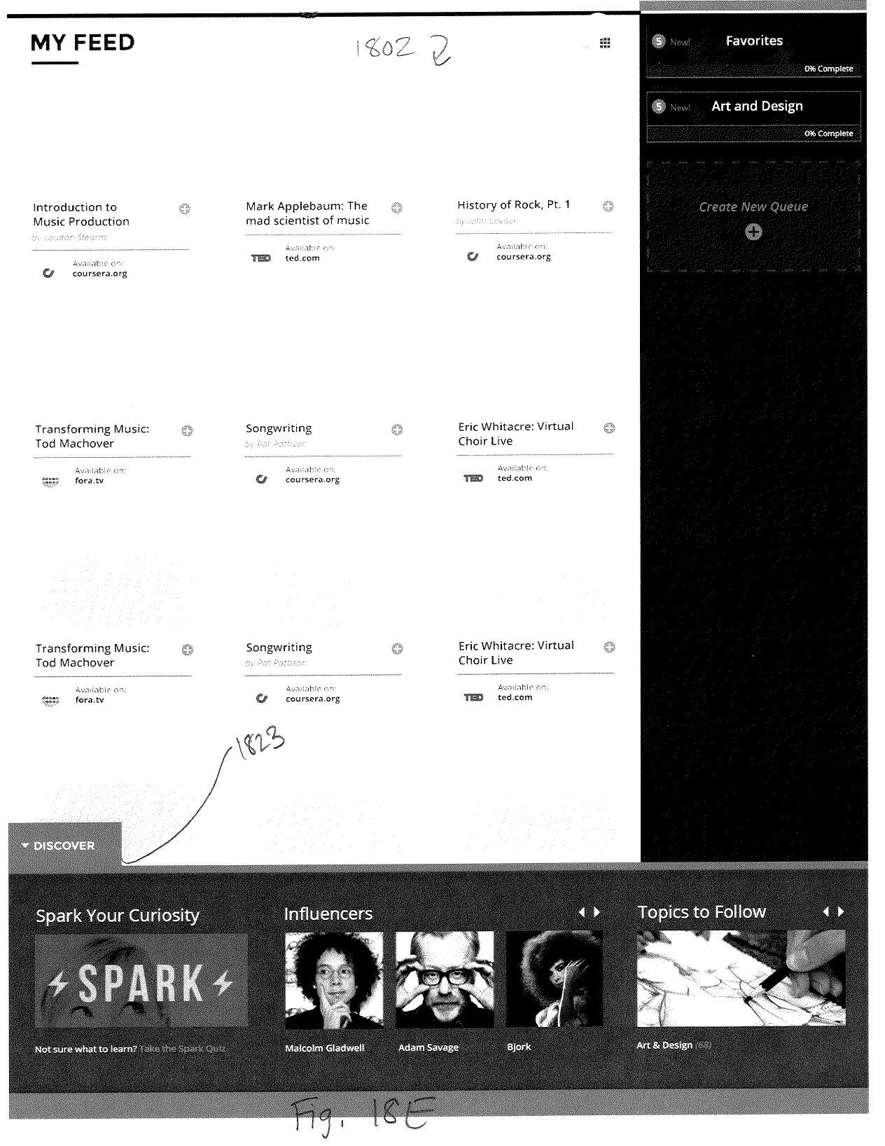

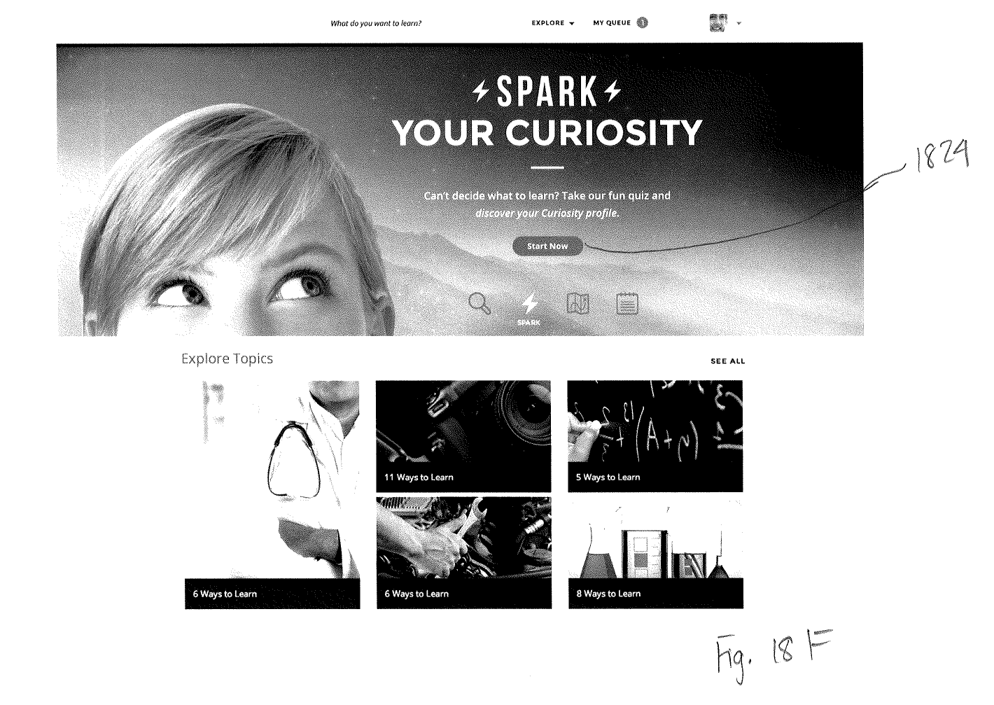

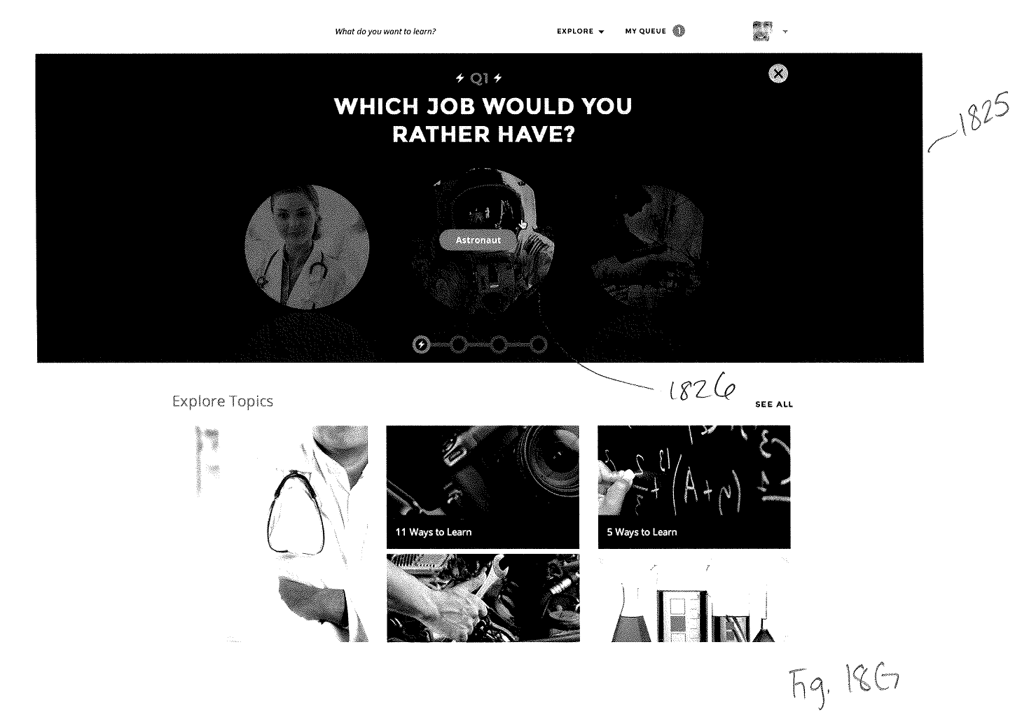

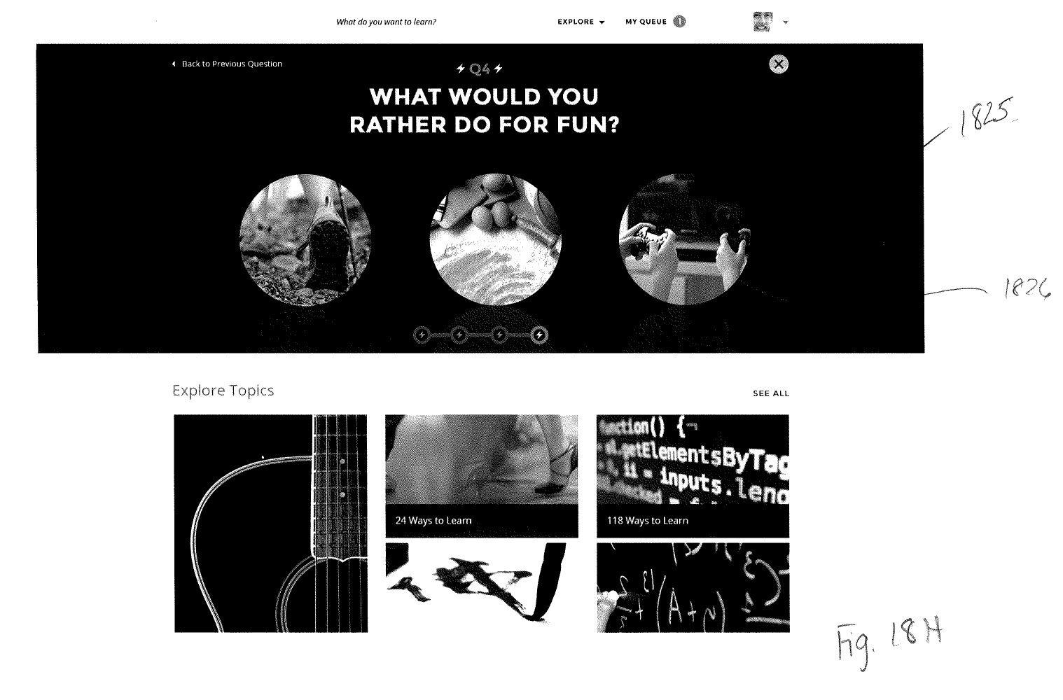

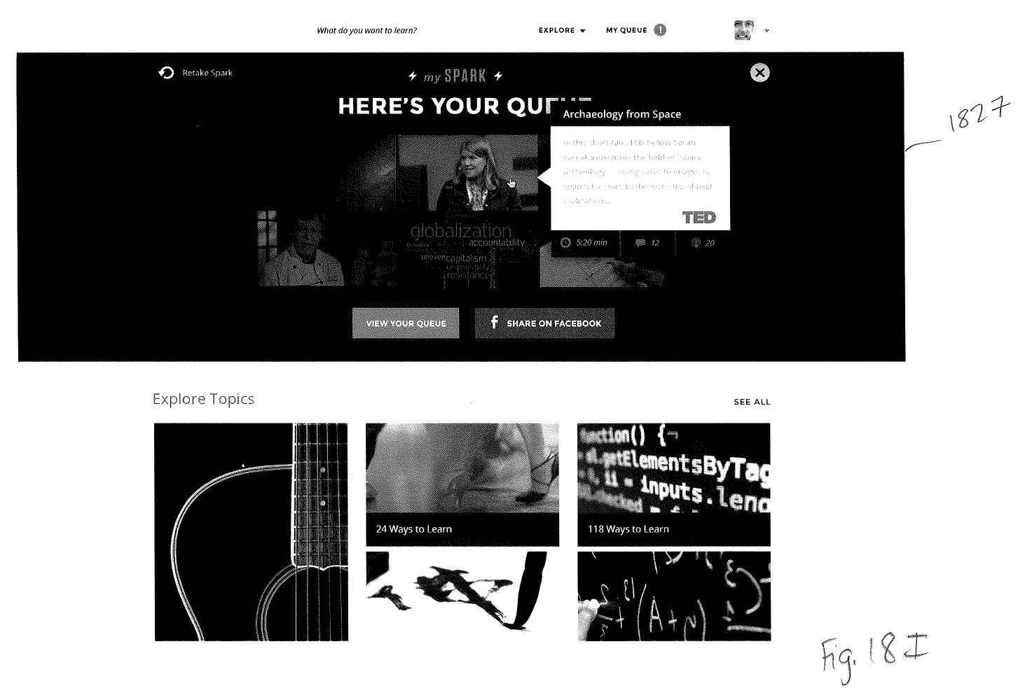

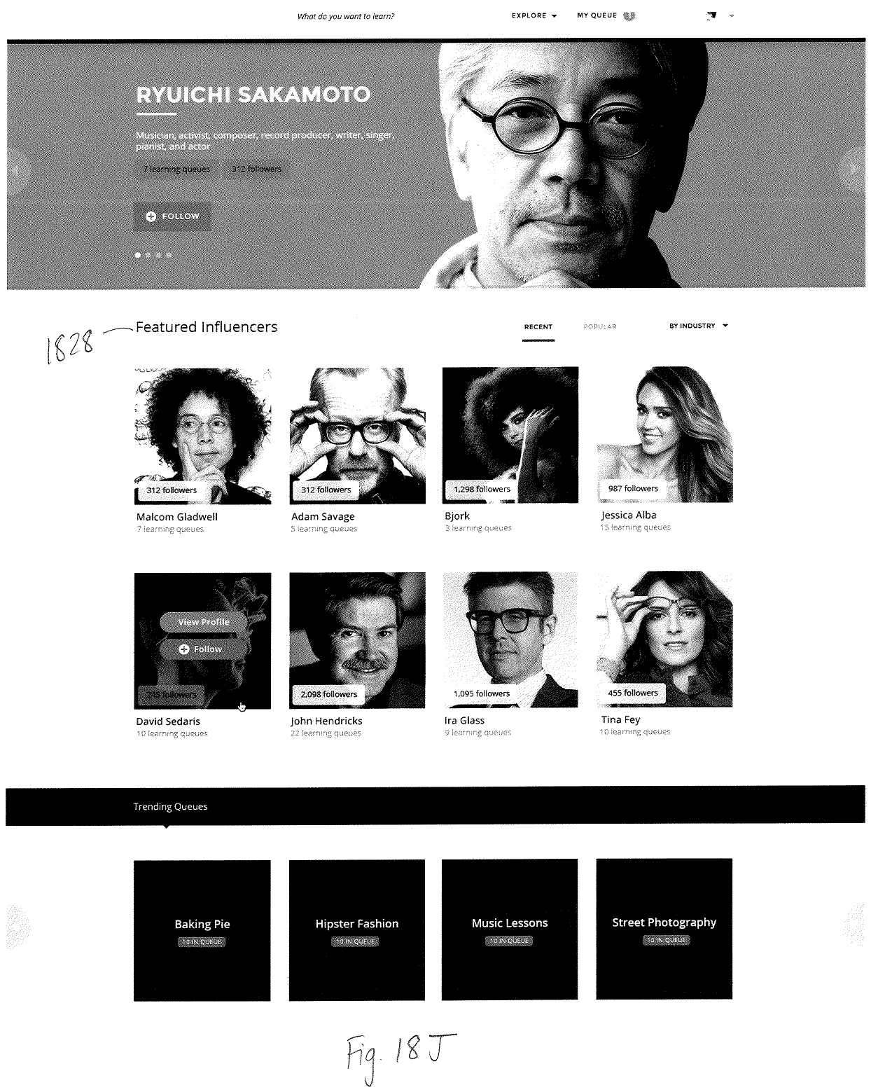

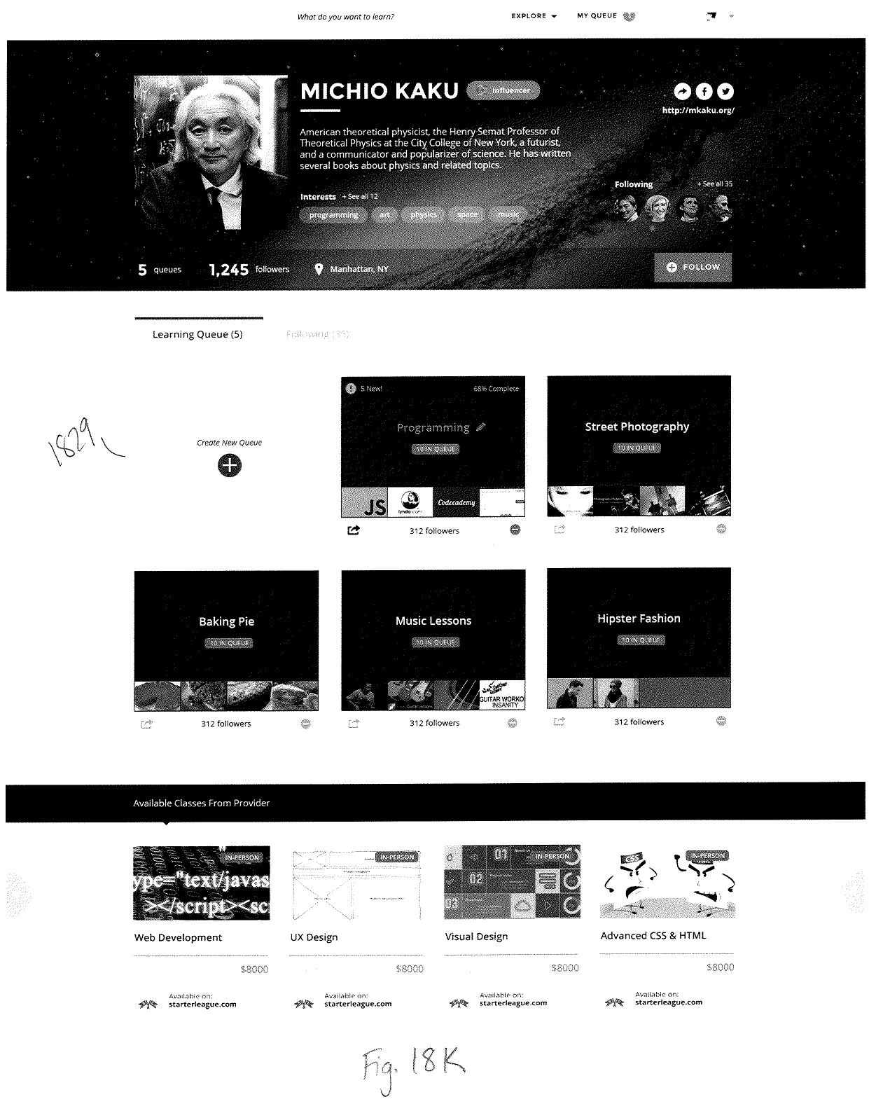

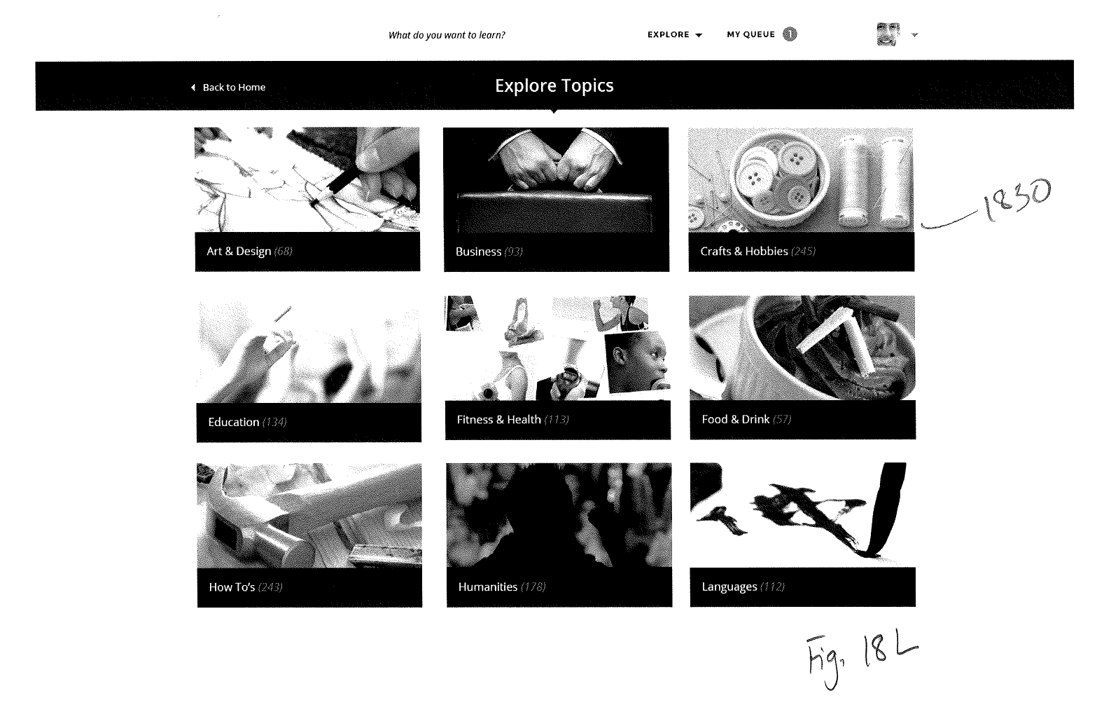

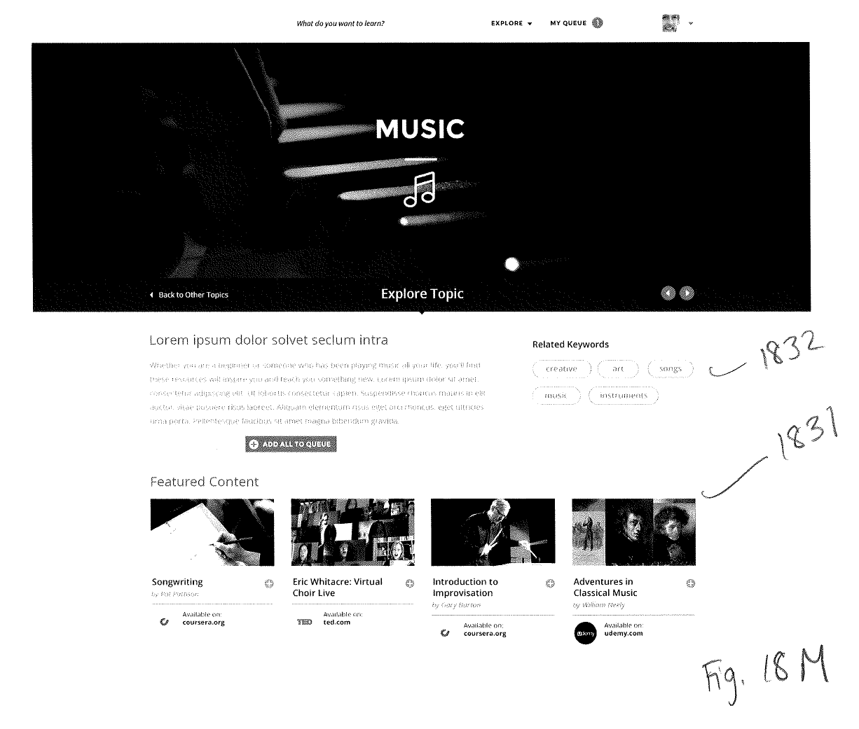

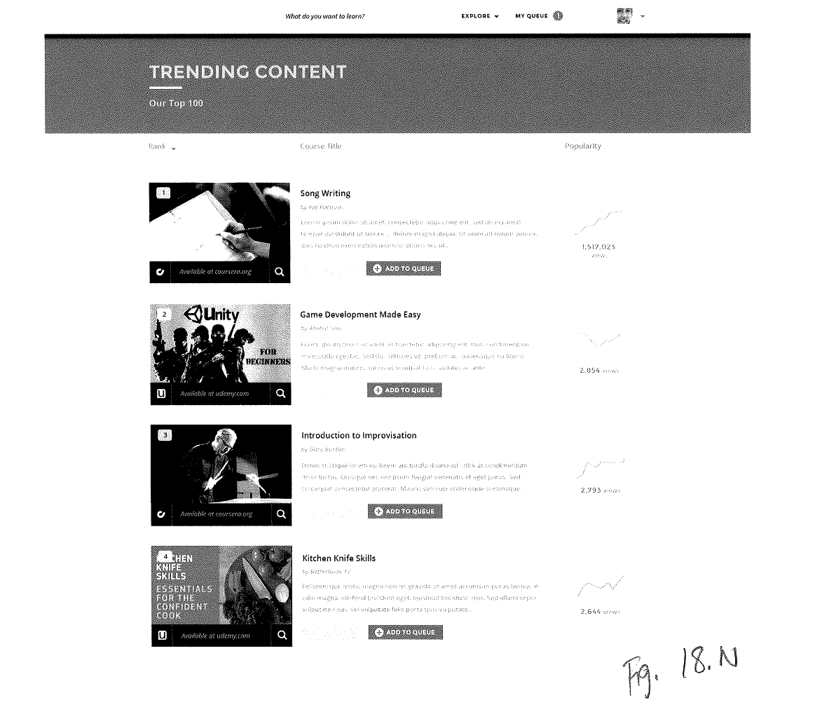

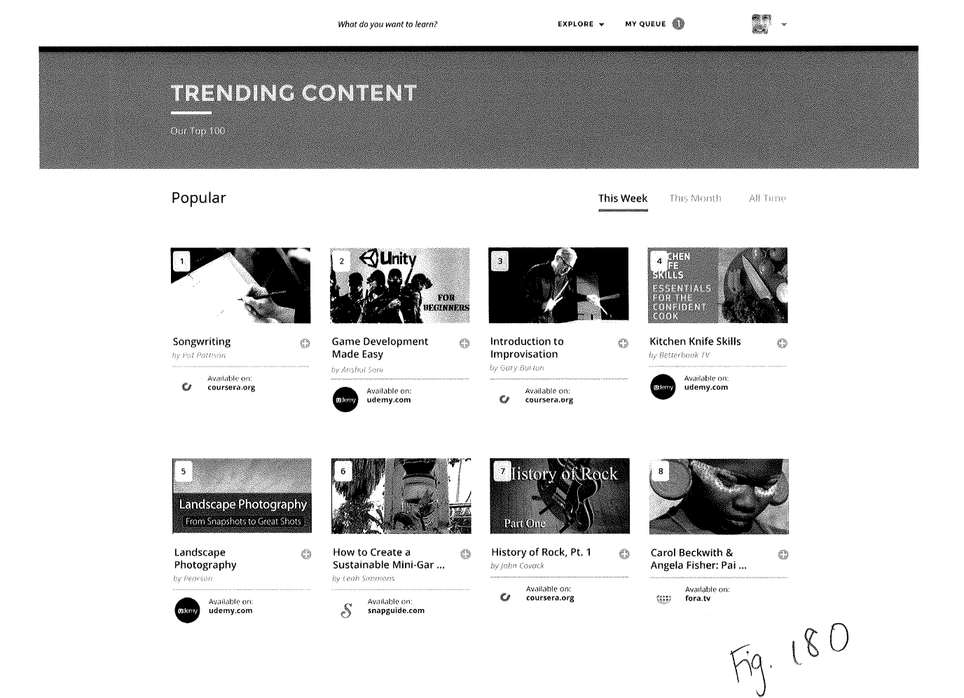

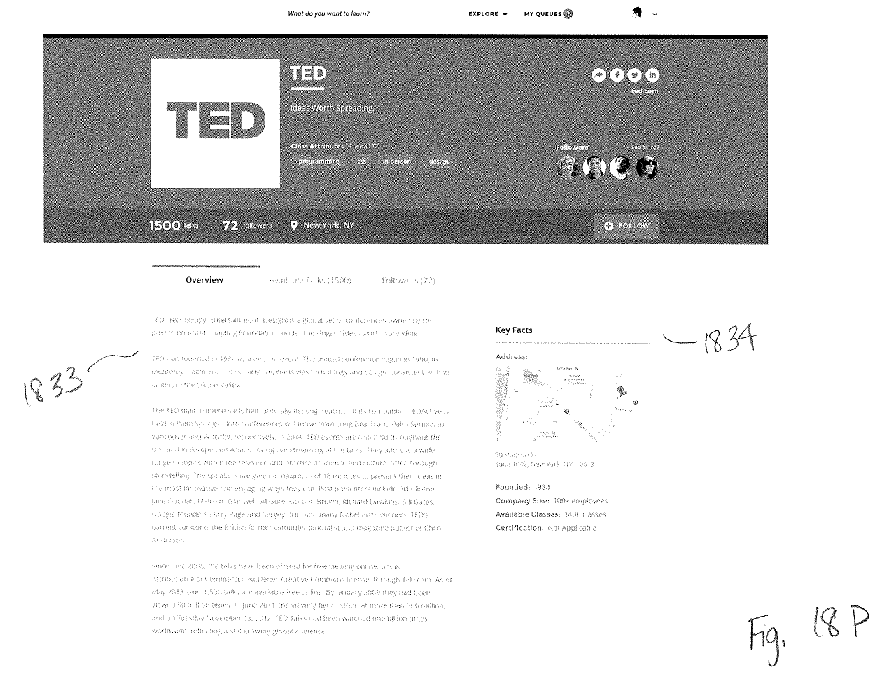

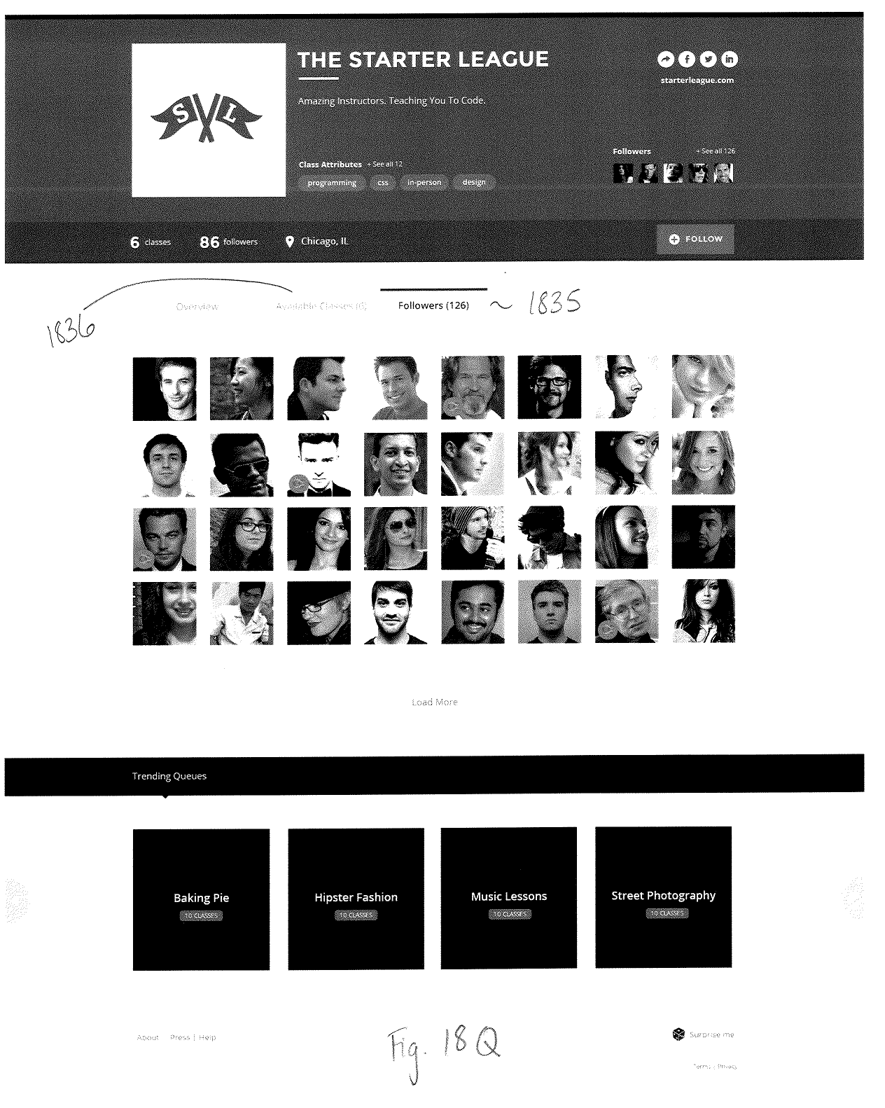

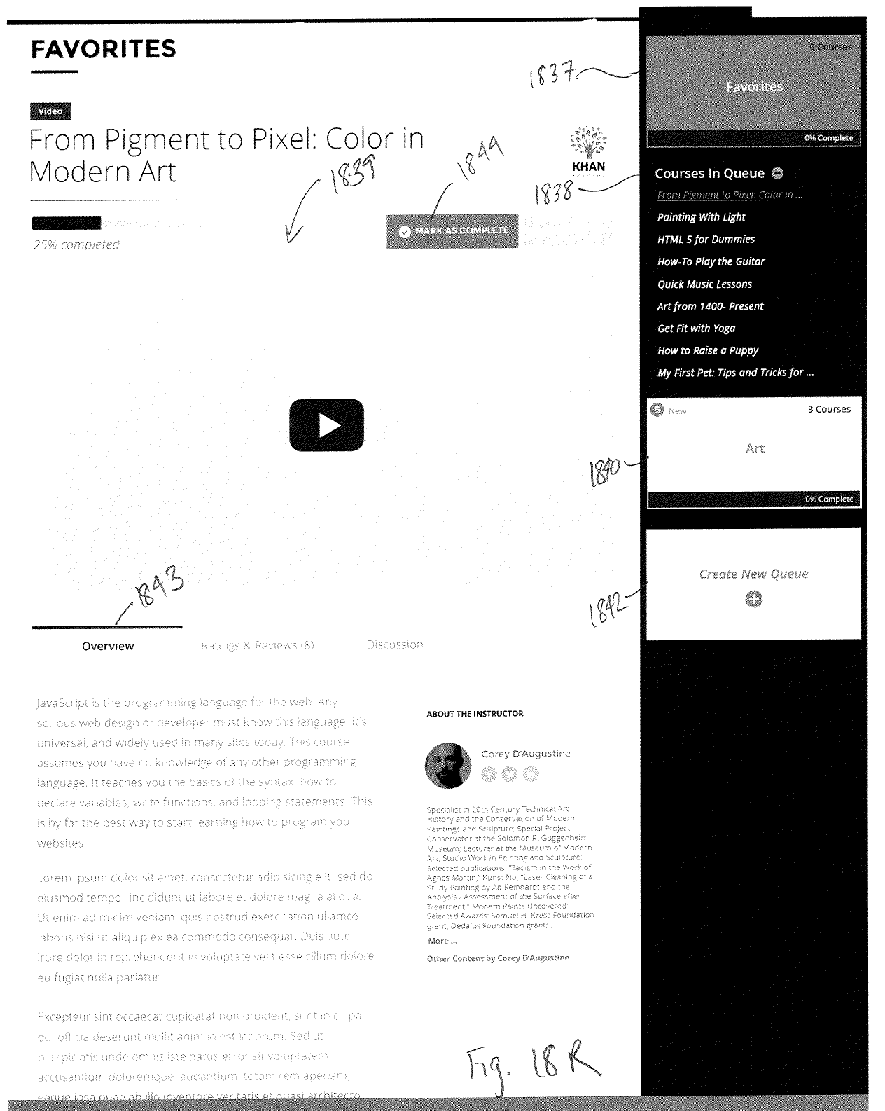

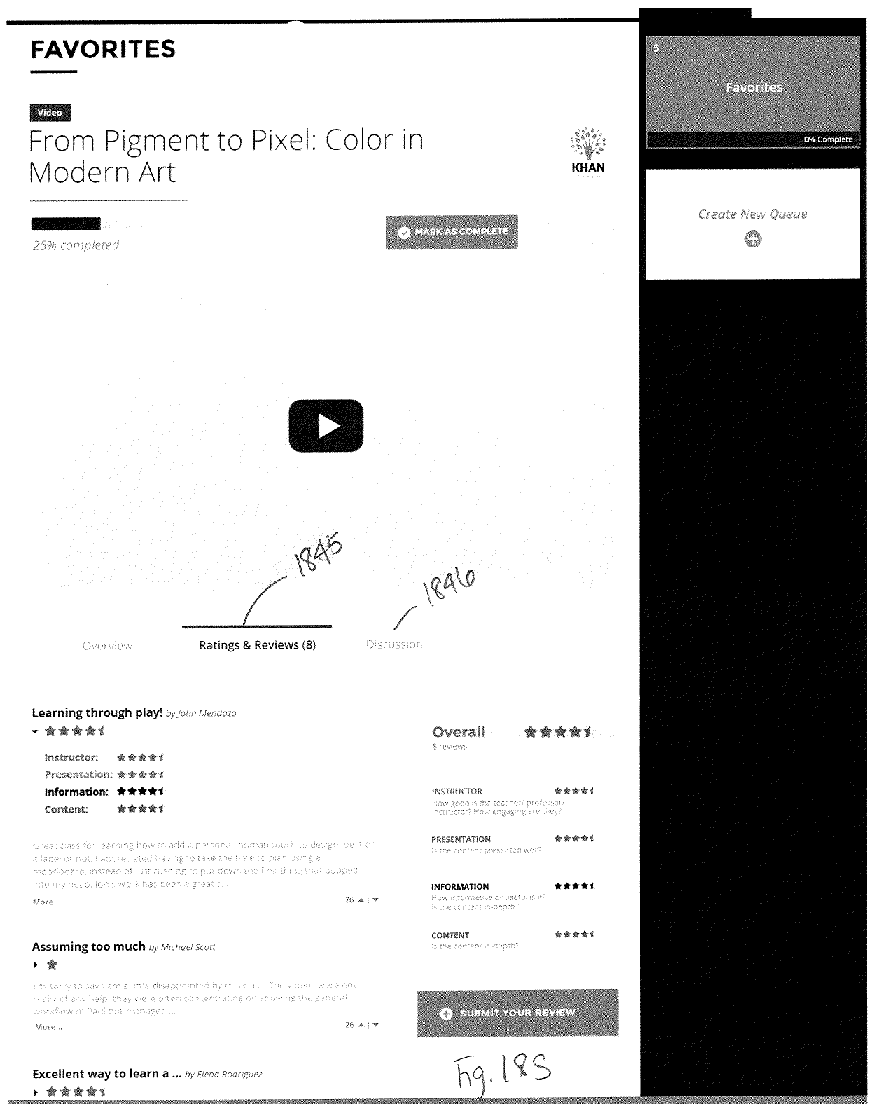

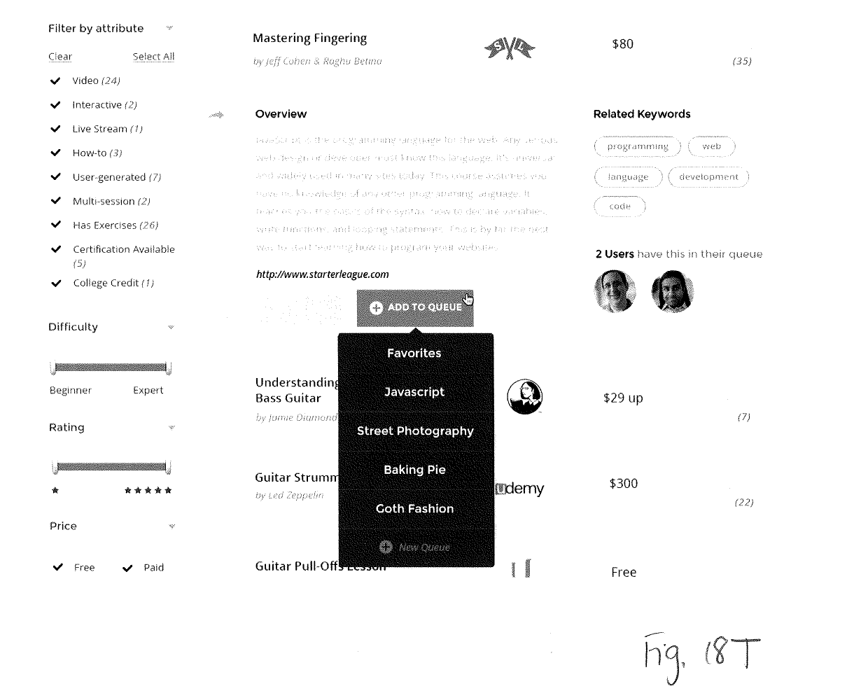

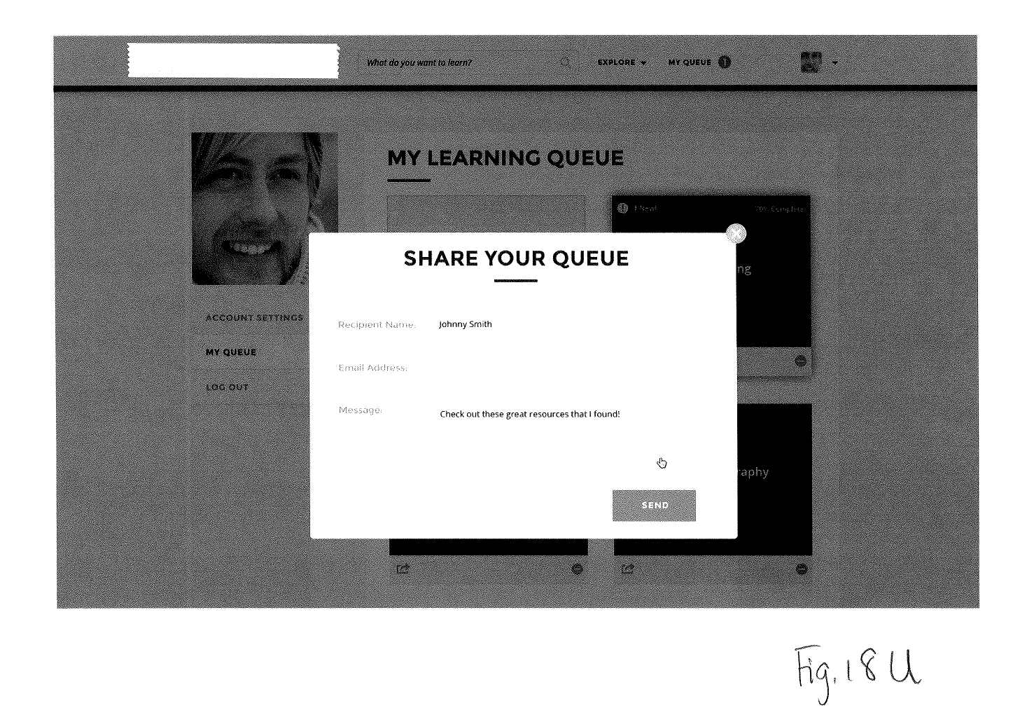

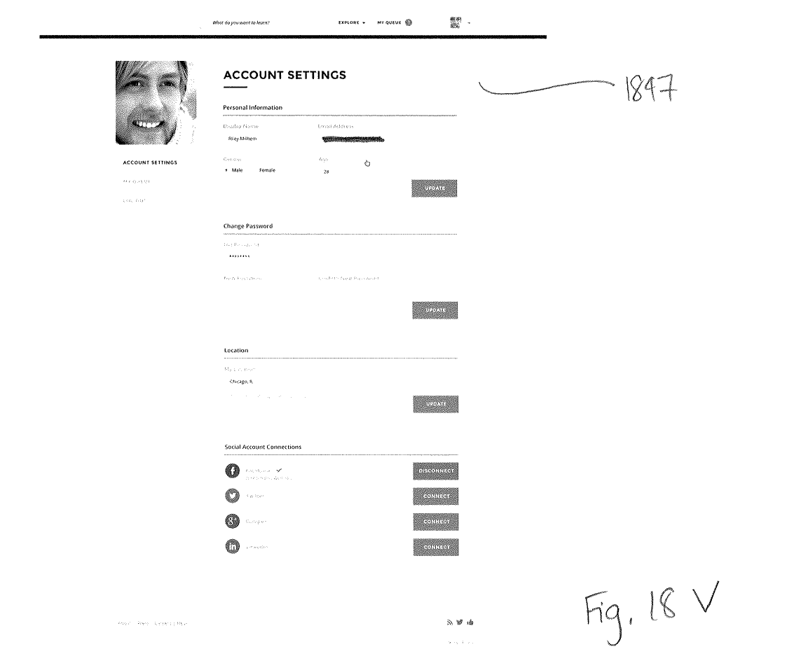

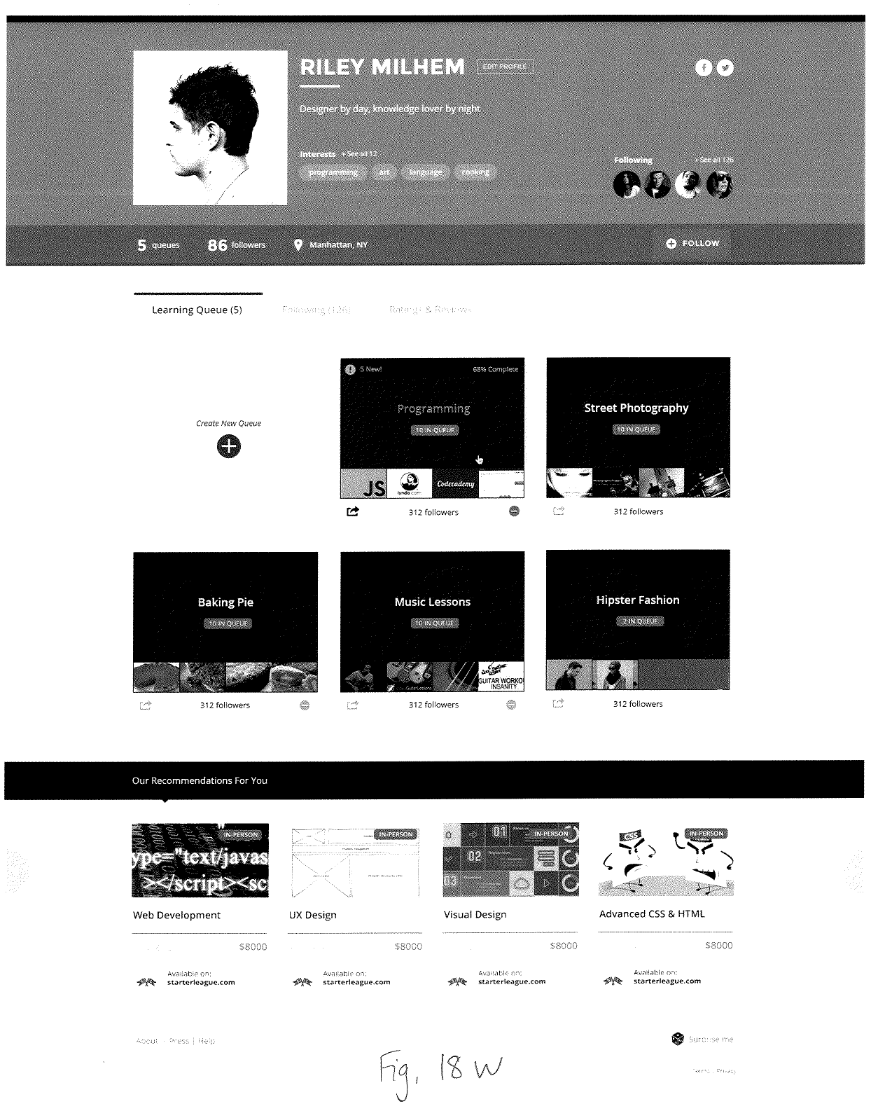

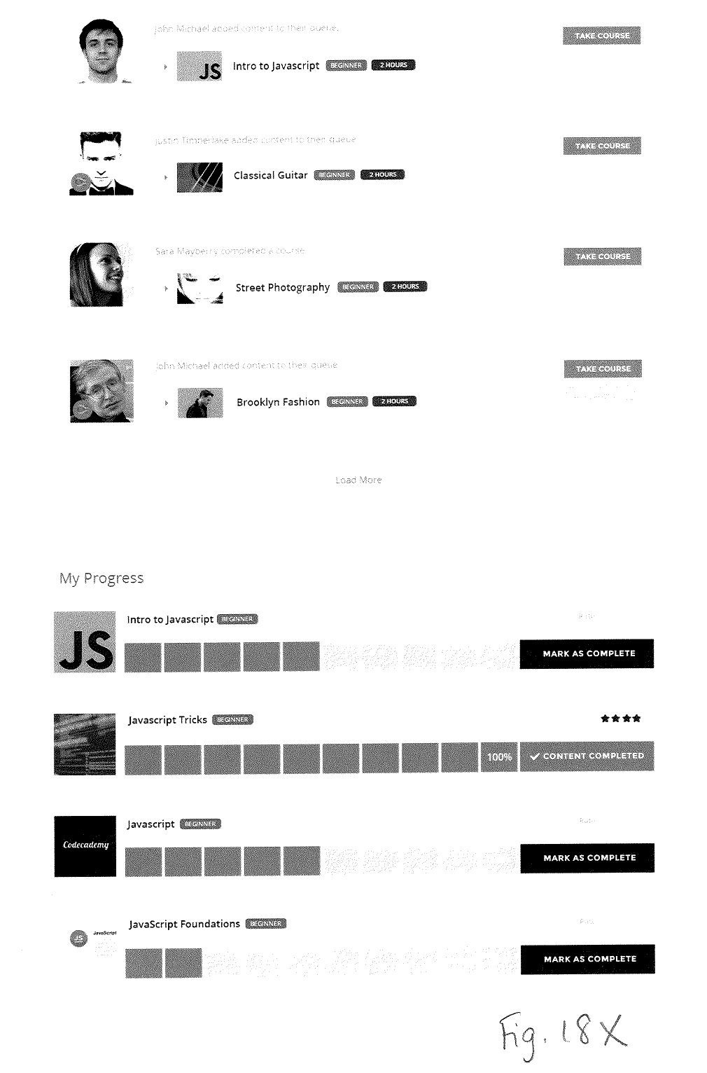

Referring now to FIGS. 18A-18X, illustrated therein are example screen shots according to various aspects of the present invention. FIGS. 18A-18C illustrate an example screen shots of search results. Referring to FIG. 18A, the search results may be presented in a content feed 1802, with one or more learning opportunities 1804 being presented. In addition, content feed 1802 may include learning information 1806 and provider information 1808.

As illustrated in FIG. 18B, the content feed 1802 may also present course overview information 1810 for a selected learning opportunity 1804. The content feed 1802 may also include ratings and/or reviews 1814 of the learning opportunities presented in the content feed 1802. A user may be able to use the course overview information and the reviews to determine whether to take the course and/or add the course to a learning queue, for example. In addition, the content feed 1802 may illustrate keywords 1812 associated with the selected learning opportunity 1804. In an aspect, a user my select one or more of the keywords 1812 as search terms and receive additional learning opportunities to be presented in the content feed 1802.

In addition, a user may filter 1816 the content feed 1802 by using one or more parameters to filter the content, as illustrated in FIG. 18C. For example, the user may filter the content by attribute, course difficulty, price, and/or provider information. It should be noted that the user may provide a variety of parameters to filter the content presented on the content feed 1802.

Referring now to FIGS. 18D and 18E, illustrated therein are example screen shots for a content feed in accordance with aspects of the present invention. FIG. 18D illustrates an example content feed 1802 with video 1820 previews of learning opportunities in the content feed 1802. In an aspect, a user may watch a video preview of the course before determining whether to take the course and/or add the course to a learning queue. FIG. 18D also illustrates user learning queues presented in a learning queue display 1822. The user may add a selected learning opportunity to the “Favorites” learning queue or the user may create a new queue. Thus, as a user adds more learning queues, the names of the learning queues may be presented next to the content feed 1802 in the learning queue display 1822.

FIG. 18E illustrates a content feed 1802 and a search box 1823 in accordance with an aspect of the present invention. Search box 1823 provides a user with multiple options for searching and/or exploring new content to add to content feed 1802. For example, a user may decide to answer questions about what the user may be interested in and thereby receive recommended content for presentation on content feed 1802. In addition, the user may select to view what other individuals may be learning about and add content from other individuals' content feeds to the user's content feed 1802. The user may also explore different topics and add learning opportunities from the topics to the content feed 1802. FIGS. 18F-18O illustrate screen shots the various search options presented to the user in accordance with aspects of the present invention.

Referring now to FIGS. 18F-18I, illustrated therein are example screen shots for questions and answers that a user may take to receive recommended content that the user may be interested in, based on the answers to the questions received. The user may start the questions by selecting the start now button 1824, as illustrated in FIG. 18F. The user may be presented with various questions 1825 and may be presented with images 1826 that the user may select in response to the questions, as illustrated in FIGS. 18G and 18H. After the user has answered the questions by selecting an image for each question, for example, the user may be presented with a learning queue 1827 with recommended learning opportunities based upon the answers provided.

Referring now to FIGS. 18J and 18K, illustrated therein are example screen shots of influencer profiles, in accordance with aspects of the present invention. FIG. 18J illustrates featured influencers 1828 that a user may select to follow and/or view the learning opportunities that the influencer is interested in and/or taking. Upon selecting an influencer, a user may view the influencer's profile page, as illustrated in FIG. 18K. The influencer's profile page may include one or more learning queues 1829 that the influencer has curated. A user may select any learning queue and see the learning opportunities included in the learning queue. In addition, the user may select to follow all the learning queues presented on the influencer's profile page or a subset of the learning queues presented on the influencer's profile page. Thus, when a user is following the learning queue, as learning opportunities are added, removed and/or completed in the learning queues, the user may be notified of the changes.

Referring now to FIGS. 18L and 18M, illustrated therein are example topic pages to explore in accordance with aspects of the present invention. FIG. 18L illustrates various topic pages 1830 that a user may explore. Topic pages may include curated courses for a particular topic. For example, topic pages may include learning opportunities selected by individuals for a particular topic. In addition, topic pages may include seasonal components or learning opportunities associated with current events. Topic pages may also have learning opportunities automatically populated, based, for example, on keywords 1832 (FIG. 18M) or other categories associated with the learning opportunities. FIG. 18M illustrates an example topic page in accordance with aspects of the present invention. The topic page may include feature content 1831 for the topic, along with keywords 1832 and other information relating to the selected topic.

FIGS. 18N and 18O illustrate example screen shots of trending content in accordance with aspects of the present invention. Trending content may include, for example, content that a large number of users have shown an interest in, courses users have taken, and/or courses users have reviewed.

FIGS. 18P and 18O illustrate example screen shots of a provider's profile page in accordance with aspects of the present invention. As illustrated in FIG. 18P, the provider profile page may include an overview 1833 of the provider, so a user may learn information about the provider and the qualifications of the provider. In addition, the provider profile page may include key facts 1834 about the provider. The provider profile page may also include the users that are following the provider 1835 and the available classes 1836 from the provider, as illustrated in FIG. 18Q. As such, a user may use the provider profile page to learn additional information about providers and determine whether the user would like to take a course offered by the provider.

Referring now to FIGS. 18R-18U, illustrated therein are example screen shots of learning queues in accordance with aspects of the present invention. FIG. 18R illustrates a selected course 1839 from a user's Favorites learning queue 1837. The user may be presented with a list of courses 1838 in the Favorites learning queue 1837. Upon selecting a course, the user may be able take the course, mark the course as complete 1844, read an overview of the course 1843, read the ratings and reviews 1845 (FIG. 18S) of the course, and/or see any discussion 1846 (FIG. 18S) that may be occurring around the course. In addition, the user may be able to select a different learning queue, e.g., the “Art” learning queue 1840, and view the courses listed in the selected learning queue. The user may also be able to create a new queue 1842. FIG. 18T illustrates an example of adding a learning opportunity to a learning queue. For example, a user may be able to add a learning opportunity to a learning queue when viewing the learning opportunity in a content feed. In addition, a user may be able to share a learning queue, as illustrated in FIG. 18U.

Referring now to FIGS. 18V-18X, illustrated therein are example screen shots for a user's profile in accordance with aspects of the present invention. A user may modify one or more account settings 1847, as illustrated in FIG. 18V. For example, the user may provide personal information (e.g., name, e-mail address, gender, age) and account information, such as passwords and location information. The user may also integrate one or more social media networks to the user profile, so that the user may share information with other individuals using one or more social media networks.

FIG. 18W illustrates a user profile page in accordance with an aspect of the present invention. The profile page may be public (e.g., other users on the system may view the profile page) or private (e.g., only the user may view the profile page). In addition, the profile page may display information about the user, the individuals the user is following (FIG. 18X), whether any individuals are following the user, the user's learning queues, and any ratings and reviews of the user, among other information. In addition, the user's profile page may illustrate the progress of the learning opportunities in the user's learning queues, as illustrated in FIG. 18X.

One variation of aspects of the present invention may include using the collected information for data mining and analysis purposes. For example, administrators of the system may use the data collected by the system to learn what courses individuals are most interested in, where individuals are learning, how individuals are learning, etc. The administrators may use this information for a variety of purposes, such as marketing products to individuals and creating new courses.

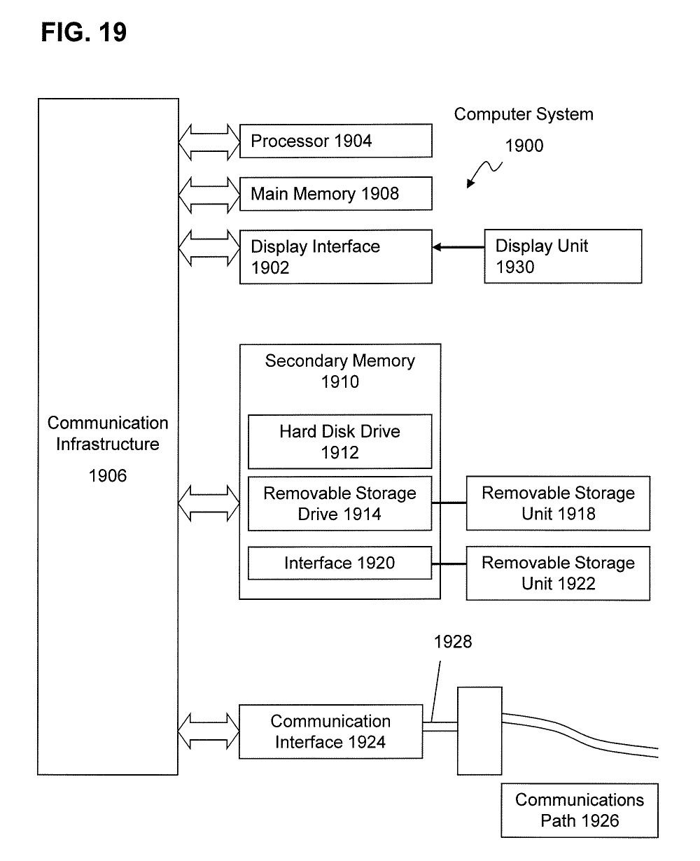

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 1900 is shown in FIG. 19.

Computer system 1900 includes one or more processors, such as processor 1904. The processor 1904 is connected to a communication infrastructure 1906 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 1900 can include a display interface 1902 that forwards graphics, text, and other data from the communication infrastructure 1906 (or from a frame buffer not shown) for display on a display unit 1930. Computer system 1900 also includes a main memory 1908, preferably random access memory (RAM), and may also include a secondary memory 1910. The secondary memory 1910 may include, for example, a hard disk drive 1912 and/or a removable storage drive 1914, representing a floppy disk drive, a magnetic tape drive, an optical disk drive, a universal serial bus (USB) flash drive, etc. The removable storage drive 1914 reads from and/or writes to a removable storage unit 1918 in a well-known manner. Removable storage unit 1918 represents a floppy disk, magnetic tape, optical disk, USB flash drive etc., which is read by and written to removable storage drive 1914. As will be appreciated, the removable storage unit 1918 includes a computer usable storage medium having stored therein computer software and/or data.

Alternative aspects of the present invention may include secondary memory 1910 and may include other similar devices for allowing computer programs or other instructions to be loaded into computer system 1900. Such devices may include, for example, a removable storage unit 1922 and an interface 1920. Examples of such may include a program cartridge and cartridge interface (such as that found in video game devices), a removable memory chip (such as an erasable programmable read only memory (EPROM), or programmable read only memory (PROM)) and associated socket, and other removable storage units 1922 and interfaces 1920, which allow software and data to be transferred from the removable storage unit 1922 to computer system 1900.

Computer system 1900 may also include a communications interface 1924. Communications interface 1924 allows software and data to be transferred between computer system 1900 and external devices. Examples of communications interface 1924 may include a modem, a network interface (such as an Ethernet card), a communications port, a Personal Computer Memory Card International Association (PCMCIA) slot and card, etc. Software and data transferred via communications interface 1924 are in the form of signals 1928, which may be electronic, electromagnetic, optical or other signals capable of being received by communications interface 1924. These signals 1928 are provided to communications interface 1924 via a communications path (e.g., channel) 1926. This path 1926 carries signals 1928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 1980, a hard disk installed in hard disk drive 1970, and signals 1928. These computer program products provide software to the computer system 1900. Aspects of the invention are directed to such computer program products.

Computer programs (also referred to as computer control logic) are stored in main memory 1908 and/or secondary memory 1910. Computer programs may also be received via communications interface 1924. Such computer programs, when executed, enable the computer system 1900 to perform the features in accordance with aspects of the present invention, as discussed herein. In particular, the computer programs, when executed, enable the processor 1904 to perform the features in accordance with aspects of the present invention. Accordingly, such computer programs represent controllers of the computer system 1900.

In an aspect of the present invention implemented using software, the software may be stored in a computer program product and loaded into computer system 1900 using removable storage drive 1914, hard drive 1912, or communications interface 1920. The control logic (software), when executed by the processor 1904, causes the processor 1904 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, various features are implemented using a combination of both hardware and software.

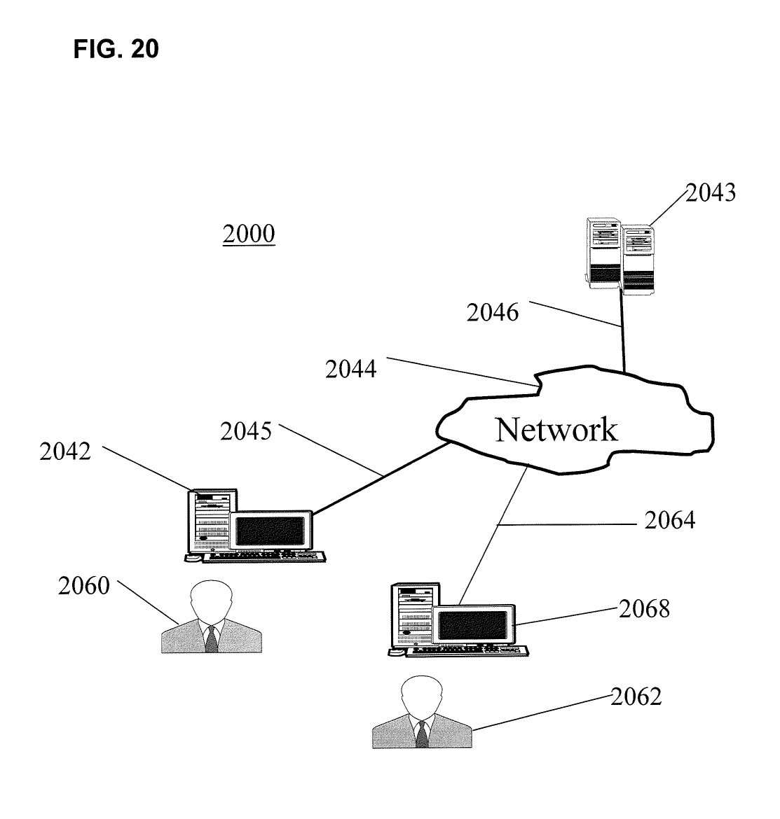

FIG. 20 shows a communication system 2000 usable in accordance with aspects of the present invention. The communication system 2000 includes one or more accessors 2060, 2062 (also referred to interchangeably herein as one or more “users”) and one or more terminals 2042, 2066. In one aspect of the present invention, data for use is, for example, input and/or accessed by accessors 2060, 2064 via terminals 2042, 2066, such as personal computers (PCs), minicomputers, mainframe computers, microcomputers, telephonic devices, or wireless devices, such as personal digital assistants (“PDAs”) or a hand-held wireless devices coupled to a server 2043, such as a PC, minicomputer, mainframe computer, microcomputer, or other device having a processor and a repository for data and/or connection to a repository for data, via, for example, a network 2044, such as the Internet or an intranet, and couplings 2045, 2046, 2064. The couplings 2045, 2046, 2064 include, for example, wired, wireless, or fiberoptic links. In another aspect of the present invention, the method and system operate in a stand-alone environment, such as on a single terminal.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. A method for generating a content feed, the method comprising:
receiving content from a plurality of sources, wherein the content includes a learning opportunity and learning information;
determining whether a source format of the content matches a system format;
a processor device transforming the source format of the received content into the system format when the source format of the content does not match the system format;
filtering and indexing the content;
populating a data repository with the indexed content in the system format; and
transmitting a content feed with the content in the system format for generation on an output mechanism.

2. The method of claim 1, wherein the learning opportunity comprises at least one selected from a group consisting of a class for professional development, a class for learning a new skill, a class for learning a hobby, and a class for learning a sport.

3. The method of claim 1, wherein learning information comprises at least one selected from a group consisting of provider information, class name, class overview information, a preview of the class, class times, class ratings, level of difficulty, class language information, instructor information, instructor rating, price, class location, modality for the class, accreditation information, and keywords.

4. The method of claim 1, further comprising:
dynamically updating the content feed as new content is received.

5. The method of claim 1, further comprising:
receiving search input for a learning opportunity; and
providing learning opportunities in the content feed based on the search input.

6. The method of claim 1, further comprising:
transmitting at least one question with at least one image associated with the at least one question for presentation to a user of a device;
receiving a selection of at least one image in response to the at least one question;
retrieving keywords associated with the selected at least one image;
searching for learning opportunities in the data repository using the keyword;
generating a learning queue with at least one learning opportunity based on the search; and
transmitting the learning queue for generation on an output mechanism on the device.

7. The method of claim 1, further comprising:
receiving a selection of a learning opportunity; and
facilitating a payment for the selected learning opportunity.

8. The method of claim 7, wherein facilitating the payment includes debiting a payment account associated with a user.

9. A system for generating a content feed, the system comprising:
a content retrieving component configured to receive content from a plurality of sources, wherein the content includes a learning opportunity and learning information;
a parser component configured to determine whether a source format of the content matches a system format and configured to transform the source format of the received content into the system format when the source format of the content does not match the system format;
a filtering component configured to filter and index the content;
a content data store configured to store the indexed content in the system format; and
a content delivery component configured to transmit a content feed with the content in the system format for generation on an output mechanism.

10. The system of claim 9, wherein the learning opportunity comprises at least one selected from a group consisting of a class for professional development, a class for learning a new skill, a class for learning a hobby, and a class for learning a sport.

11. The system of claim 9, wherein learning information comprises at least one selected from a group consisting of provider information, class name, class overview information, a preview of the class, class times, class ratings, level of difficulty, class language information, instructor information, instructor rating, price, class location, modality for the class, accreditation information, and keywords.

12. The system of claim 9, wherein the content delivery component is further configured to dynamically update the content feed upon new content being received.

13. The system of claim 9, further comprising:
a receiving component configured to receive search input for a learning opportunity; and
the content delivery component being further configured to provide learning opportunities in the content feed based on the search input.

14. The system of claim 9, wherein the content delivery component is further configured to transmit one or more questions with images associated with the questions for presentation to a user of a device;
wherein a recommending component is configured to receive a selection of images in response to the questions, retrieve keywords associated with the selected images, search for learning opportunities in the data repository using the keyword, and generate a learning queue with at least one learning opportunity based on the search; and
wherein the content delivery component is further configured to transmit the learning queue for generation on an output mechanism on the device.

15. The system of claim 9, further comprising:
a payment component configured to receive a selection of a learning opportunity and facilitate a payment for the selected learning opportunity.

16. The system of claim 15, wherein the payment component is configured to debit a payment account associated with a user.

17. A computer product comprising a computer usable medium having control logic stored therein for causing the computer to generate a content feed, the control logic comprising:
at least one instruction for causing the computer to receive content from a plurality of sources, wherein the content includes a learning opportunity and learning information;
at least one instruction for causing the computer to determine whether a source format of the content matches a system format;
at least one instruction for causing the computer to transform the source format of the received content into the system format when the source format of the content does not match the system format;
at least one instruction for causing the computer to filter and index the content;
at least one instruction for causing the computer to populate a data repository with the indexed content in the system format; and
at least one instruction for causing the computer to transmit a content feed with the content in the system format for generation on an output mechanism.

18. A method of creating learning queues, the method comprising:
receiving a content feed with one or more learning opportunities;
receiving a selection of at least one learning opportunity from the content feed;
adding the selected learning opportunity to a learning queue;
receiving a learning opportunity status for the selected learning opportunity;
a processing device updating the learning queue with the learning opportunity status; and
presenting the learning queue, via the processing device, with the selected learning opportunity and the learning opportunity status.

19. The method of claim 18, wherein the learning opportunity status comprises at least one selected from a group consisting of completed, in progress, not started, and canceled.

20. The method of claim 18, further comprising:
sharing the learning queue with other individuals.

21. The method of claim 18, further comprising:
adding additional learning opportunities from the content feed to the learning queue.

22. The method of claim 18, further comprising:
receiving reviews of the selected learning opportunity; and
presenting the reviews for the selected learning opportunity.

23. A system for creating learning queues, the system comprising:
a display component configured to receive a content feed with at least one learning opportunity;
a selection component configured to receive a selection of at least one learning opportunity from the content feed;
a learning queue component configured to add the selected learning opportunity to a learning queue, receive a learning opportunity status for the selected learning opportunity, and update the learning queue with the learning opportunity status; and
the display component configured further to present the learning queue with the selected learning opportunity and the learning opportunity status.

24. The system of claim 23, wherein the learning opportunity status comprises at least one selected from a group consisting of completed, in progress, not started, and canceled.

25. The system of claim 23, further comprising:
a sharing component configured to share the learning queue with other individuals.

26. The system of claim 23, wherein the learning queue component is further configured to add additional learning opportunities from the content feed to the learning queue.

27. The system of claim 23, further comprising:
a feedback component configured to receive reviews of the selected learning opportunity; and
the display component being further configured to present the reviews for the selected learning opportunity.

28. A computer product comprising a computer usable medium having control logic stored therein for causing the computer to create learning queues, the control logic comprising:
at least one instruction for causing the computer to receive a content feed with at least one learning opportunities;
at least one instruction for causing the computer to receive a selection of at least one learning opportunity from the content feed;
at least one instruction for causing the computer to add the selected learning opportunity to a learning queue;
at least one instruction for causing the computer to receive a learning opportunity status for the selected learning opportunity;
at least one instruction for causing the computer to update the learning queue with the learning opportunity status; and
at least one instruction for causing the computer to present the learning queue with the selected learning opportunity and the learning opportunity status.
